(19) United States
(12) Patent Application Publication
(10) Pub. No.: US 2008/0204197 A1
(43) Pub. Date: Aug. 28, 2008

(54) Memory carrier and method for driving the same

(75) Inventor: Yutaka Shionoiri, Isehara (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 12/068,395

(22) Filed: Feb. 6, 2008

(30) Foreign Application Priority Data
Feb. 23, 2007 (JP) 2007-043066

(51) Int. Cl. H04Q 5/22

(52) U.S. Cl. 340/10.1

(57) ABSTRACT

A contactless memory carrier for which it is not necessary to fabricate a barcode and a tag using separate processes is provided. The memory carrier includes a memory which stores data; a control circuit which reads the data from the memory in accordance with a signal transmitted contactlessly from an interrogator; a converter which converts the read data in accordance with an algorithm; an image signal generating circuit which uses the data converted by the converter to generate an image signal; and a display device which uses the image signal to display a code. The data converted in accordance with the algorithm may be stored in the memory in advance. In that case, it is not necessary to provide the converter for converting data in accordance with the algorithm.

### BACKGROUND OF THE INVENTION

1. Field of the Invention

The present invention relates to memory carriers which transmit and receive signals wirelessly.

2. Description of the Related Art

Practical application of technology which identifies individual objects by transmitting and receiving signals wirelessly (RFID: radio frequency identification) is proceeding in various fields, and further expansion of the market for such technology as a new mode of communication of information is expected. In RFID, generally, signals are transmitted and received wirelessly between an interrogator, which is referred to as a reader, a reader/writer, or an interrogator, and an RF tag. When identification information is stored in the RF tag and signals are transmitted and received wirelessly between the interrogator and the RF tag, the identification information stored in the RF tag can be read contactlessly, and an individual object which it is desired to identify can be identified. RF tags often take the form of cards, or chips, which are smaller than cards; however, they can take various forms depending on intended uses.

Identification information can be stored in a memory included in the RF tag. Depending on the type of memory included, an RF tag is classified as an RF tag whose identification information is not rewritable or as an RF tag whose identification information is rewritable. In the case of RF tags whose data is not rewritable, basically written identification information continues to be stored as is. Similarly, in the case of RF tags whose data is rewritable, generally identification information is not rewritten during the period of a series of usages; however, RF tags whose data is rewritable differ from RF tags whose data is not rewritable in that after a series of usages has been completed, the identification information can be rewritten and thus the RF tag can be reused.

Meanwhile, the current situation is that compared to bar codes, the reliability of RF tags when data such as identification information is being read is not high enough such that RF tags are suitable for practical use. When RF tags are used it is estimated that about one percent of operations are malfunctions in which read data is incorrect or in which data cannot be read, so RF tags have not yet reached a level where they can be put to practical use. Therefore, there is a trend towards realizing practical application of RF tags by combining an RF tag with a bar code, to provide for the case where a malfunction occurs when the RF tag is being read. In Patent Document 1 (Japanese Published Patent Application No. 2001-5931), a seal for a bar code which has an RFID function is disclosed.

### SUMMARY OF THE INVENTION

Bar codes are inconvenient in that it is necessary for reading to be performed at close range, so communication range must be shortened; however, bar codes have an advantage in that malfunctions rarely occur during reading, unlike when RF tags are used. Therefore, when a bar code is combined with an RF tag, data can be read accurately almost all of the time, even in the case where a malfunction occurs when the RF tag is being read. Further, when a database for linking data included in the bar code and identification information included in the RF tag is prepared in advance, and identification information in the RF tag is extracted from data in the bar code using the database, an individual object can be identified even in the case where a malfunction occurs when the RF tag is being read.

However, in the case where a bar code and an RF tag are combined, they must each be fabricated using separate processes. Further, data of the bar code can easily be read visually, so in the case where it is desired that identification information be kept confidential, from a security point of view it is undesirable that the bar code, whose data which is linked to the identification information can be easily read visually, be used.

Further, in the case of an RF tag whose data is rewritable, when the RF tag is reused, it is necessary to rewrite a stored identification number. In that case, because data included in the bar code is not rewritable, the bar code which is combined with the RF tag must be replaced, and this task is troublesome.

In view of the above, an object of the present invention is to provide a memory carrier for which it is not necessary to fabricate a bar code and an RF tag using separate processes. Further, an object of the present invention is to provide a memory carrier for which it is possible to select whether or not a bar code will be displayed. Furthermore, an object of the present invention is to provide a memory carrier for which the troublesomeness of the task of replacing a bar code in the case where data is rewritten can be eliminated.

A memory carrier of the invention can receive a signal sent wirelessly from an interrogator, which is referred to as a reader, a reader/writer, or an interrogator, and in accordance with that signal, can wirelessly transmit a signal, which includes data which is stored in a memory, to the interrogator; and includes a display device which displays a code, which is for reading data stored in the memory using optical mark recognition. When the display device is included in the memory carrier, in a case where a malfunction of some sort occurs in the memory carrier and the interrogator cannot recognize data stored in the memory, the data can be optically read from the code displayed in the display device.

Specifically, the memory carrier of the invention includes a memory for storing data; a control circuit which reads the data from the memory in accordance with a signal transmitted wirelessly from the interrogator; a converter which converts the read data in accordance with an algorithm; an image signal generating circuit which generates an image signal using the data converted by the converter; and a display device which displays a code using the image signal.

Note that the code may be a one-dimensional code (a bar code) or a two-dimensional code. Any type of code can be used, as long as it is a code from which data can be optically read. Further, the memory carrier may include an antenna circuit for wirelessly transmitting and receiving signals to and from the interrogator.

Further, in the memory carrier of the invention, an integrated circuit, which includes the memory, the control circuit, a modulation circuit, the converter, the image signal generating circuit, or the like, and the display device may be formed over one substrate.

Further, in the invention, data converted in accordance with the algorithm may be stored in the memory. In that case, the converter for converting in accordance with the algorithm does not have to be provided within the memory carrier. Further, data which has not yet been converted and data which has been converted may be stored in separate regions within one memory, or may be stored in separate memories.

Further, the display device includes a pixel portion which includes a plurality of pixels, and a driver circuit for controlling drive of the pixel portion in accordance with an image signal. Each pixel includes a display element which can display at least two values of gray scale in accordance with the image signal. Further, as the display elements, elements which can control gray scale by application of voltage and which have a memory property, such as elements used in display devices which are referred to as electronic paper or digital paper, can be used, for example.

Specifically, in the display device, a display element such as a non-aqueous electrophoretic display element; a display element which uses a PDLC (polymer dispersed liquid crystal) method, in which liquid crystal droplets are dispersed in a high polymer material which is between two electrodes; a display element which includes chiral nematic liquid crystal or cholesteric liquid crystal between two electrodes; a display element which includes charged fine particles between two electrodes and employs a particle-moving method in which the charged fine particles are moved through fine particles by using an electric field; or the like can be used. Further, a non-aqueous electrophoretic display element may be a display element in which a dispersion liquid, in which charged fine particles are dispersed, is sandwiched between two electrodes; a display element in which a dispersion liquid in which charged fine particles are dispersed is included over two electrodes between which an insulating film is interposed; a display element in which twisting balls having hemispheres which are different colors which charge differently are dispersed in a solvent between two electrodes; a display element which includes microcapsules, in which a plurality of charged fine particles are dispersed in a solution, between two electrodes; or the like.

Further, a light-emitting element typified by an organic light-emitting element (OLED); a liquid crystal element; or the like can also be used as a display element in the display device.

In the memory carrier of the invention, the display device is formed over the same substrate as the integrated circuit, and the code is displayed in the display device; and thus, the need for forming the code and the integrated circuit separately, as is done conventionally, disappears.

Further, whether or not the code is displayed in the display device of the memory carrier of the invention can be selected. Therefore, various applications which are not possible with a conventional RF tag which has a bar code can be anticipated; for example, in the case where it is desired that a security level be increased, the code is not displayed.

Further, concerning the memory carrier of the invention, in the case where data is rewritten in the memory, the code displayed can be changed to suit the data. Therefore, the troublesomeness of replacing the code can be eliminated.

### BRIEF DESCRIPTION OF THE DRAWINGS

FIGS. 1A and 1B are block diagrams which show structures of a memory carrier of the invention.

FIG. 2 is a block diagram which shows a structure of a memory carrier of the invention.

FIG. 3 is a block diagram which shows a structure of a memory carrier of the invention.

FIG. 4 is a block diagram which shows a structure of a memory carrier of the invention.

FIG. 5 is a block diagram which shows a structure of a memory carrier of the invention.

FIG. 6 is a block diagram which shows a structure of a memory carrier of the invention.

FIG. 7 is a block diagram which shows a structure of a memory carrier of the invention.

FIGS. 8A and 8B are perspective views which show a structure of a memory carrier of the invention.

FIGS. 9A and 9B are a top view and a cross-sectional view, respectively, which show a structure of a pixel portion which is included in a memory carrier of the invention.

FIGS. 10A and 10B are a top view and a cross-sectional view, respectively, which show a structure of a pixel portion which is included in a memory carrier of the invention.

FIGS. 11A and 11B are top views which show structures of a pixel portion which is included in a memory carrier of the invention.

FIGS. 12A and 12B are top views which show structures of a pixel portion which is included in a memory carrier of the invention.

FIGS. 13A to 13C are views which show a method of fabricating a memory carrier of the invention.

FIGS. 14A to 14C are views which show a method of fabricating a memory carrier of the invention.

FIGS. 15A to 15C are views which show a method of fabricating a memory carrier of the invention.

FIGS. 16A and 16B are views which show a method of fabricating a memory carrier of the invention.

FIGS. 17A and 17B are views which show a method of fabricating a memory carrier of the invention.

### DETAILED DESCRIPTION OF THE INVENTION

Hereinafter, embodiment modes of the invention will be described with reference to the accompanying drawings. However, the invention can be carried out in many different modes, and those skilled in the art will readily appreciate that a variety of modifications can be made to the modes and their details without departing from the spirit and scope of the invention. Accordingly, the invention should not be construed as being limited to the description of the embodiment modes.

### Embodiment Mode 1

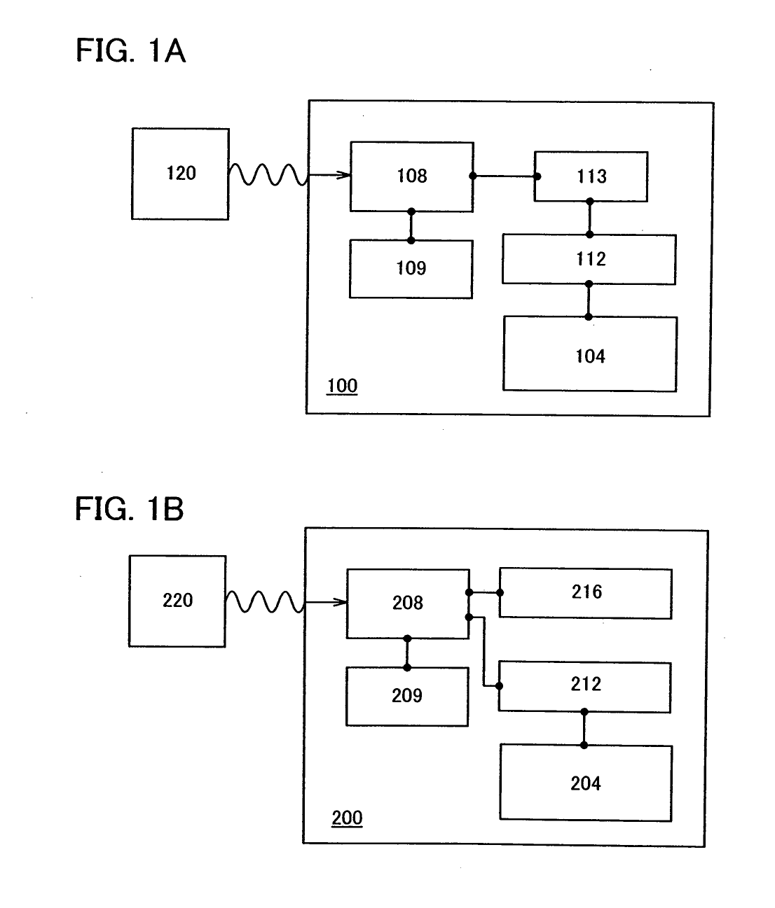

A structure of a memory carrier of the invention will be described with reference to FIG. 1A. FIG. 1A is a block diagram which schematically shows a mode of a memory carrier of the invention. A memory carrier 100 in FIG. 1A includes a memory 109 for storing data; a control circuit 108 which reads data from the memory 109 in accordance with a signal transmitted wirelessly from an interrogator 120; a converter 113 which converts the read data in accordance with an algorithm; an image signal generating circuit 112 which uses the data converted by the converter 113 to generate an image signal; and a display device 104 which uses the image signal to display a code.

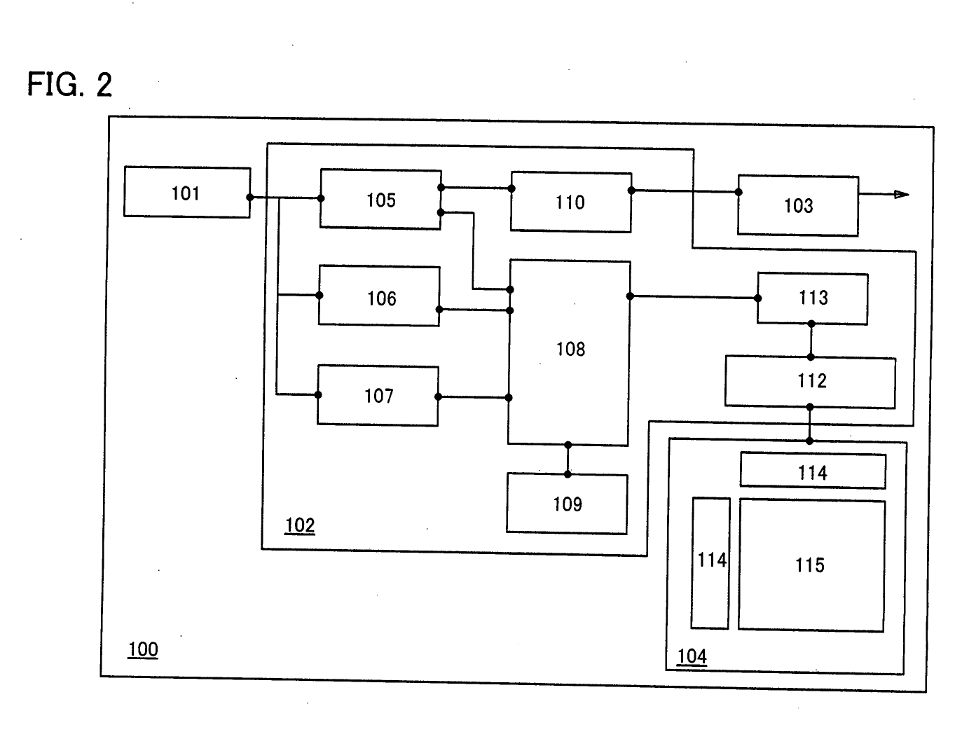

An example of a more specific structure of the memory carrier 100 shown in FIG. 1A is shown in FIG. 2. FIG. 2 is a block diagram which shows a mode of a memory carrier of the invention. The memory carrier 100 in FIG. 2 includes an antenna circuit 101, an integrated circuit 102, a storage battery 103, and the display device 104. The integrated circuit 102 includes a power supply circuit 105, a demodulation circuit 106, a modulation circuit 107, the control circuit 108, the memory 109, a charging circuit 110, the image signal generating circuit 112, and the converter 113. The display device 104 includes driver circuits 114 and a pixel portion 115.

When a signal is transmitted wirelessly from the interrogator 120, the signal is received in the antenna circuit 101, and a signal which includes an instruction from the interrogator is generated. The demodulation circuit 106 demodulates the signal generated in the antenna circuit 101, and outputs the signal to the control circuit 108 of a subsequent stage. The control circuit 108 analyzes the signal inputted from the demodulation circuit 106, and reads data stored in the memory 109 in accordance with content of the instruction transmitted from the interrogator 120. Note that the control circuit 108 can perform arithmetic processing in accordance with the signal input from the demodulation circuit 106. When the arithmetic processing is performed, part of a region of the memory 109 or a separately provided memory can be used as a primary cache memory or a secondary cache memory.

A signal for output which includes data read from the memory 109 is encoded in the control circuit 108 and then transmitted to the modulation circuit 107. In accordance with that signal, the modulation circuit 107 modulates a wireless signal that is received by the antenna circuit 101. The modulated wireless signal is received by the interrogator 120. According to the above-described series of operations, data in the memory 109 included in the memory carrier 100 can be wirelessly transmitted to the interrogator 120. Accordingly, data of the memory carrier 100, such as identification information or the like, can be recognized.

Meanwhile, the power supply circuit 105 generates a power supply voltage by rectifying and smoothing a voltage of the signal received by the antenna circuit 101. The power supply voltage generated in the power supply circuit 105 is supplied to the control circuit 108 and the charging circuit 110. Note that alternatively, a structure may be employed in which after the signal received by the antenna circuit 101 has been rectified and smoothed, the voltage is stabilized by a voltage regulator circuit such as a regulator or the like and is then supplied to the control circuit 108 and the charging circuit 110 as a power supply voltage. The charging circuit 110 adjusts the level of the power supply voltage from the power supply circuit 105 and uses the adjusted voltage to charge the storage battery 103. Further, the power supply voltage generated in the power supply circuit 105 is supplied to various circuits in the integrated circuit 102, such as the demodulation circuit 106, the modulation circuit 107, the control circuit 108, the memory 109, the image signal generating circuit 112, and the converter 113, and to the display device 104.

Note that a charge control circuit for controlling the power supply circuit 105 may be provided in the integrated circuit 102 so that excessive charging of the storage battery 103 is prevented. Further, the power supply circuit 105 can include a rectifier circuit, a smoothing capacitor, a regulator, a switching circuit, and the like. When a diode is used for the switching circuit, excessive charging of the storage battery 103 can be suppressed without using a charge control circuit.

Further, in the memory carrier 100 of the invention, data stored in the memory 109 is read by the control circuit 108 in accordance with a signal from the demodulation circuit 106, and transmitted to the converter 113. The converter 113 generates an image signal for displaying a code by converting the inputted data in accordance with a predetermined algorithm, and outputs the image signal to the image signal generating circuit 112. The algorithm may be stored in the memory 109, or in a separately prepared memory. The converter 113 converts the data using the algorithm which has been read from the memory by the control circuit 108. The image signal generating circuit 112 performs signal processing on the inputted image signal to suit specifications of the display device 104, and inputs the image signal to the display device 104.

In the display device 104, when the driver circuits 114 control operation of the pixel portion 115 in accordance with the inputted image signal, a code which corresponds to data stored in the memory 109 is displayed in the pixel portion 115. Data can be optically read by a scanner or the like from the code displayed in the pixel portion 115.

Note that the displayed code may be a one-dimensional code (a bar code) or a two-dimensional code. Alternatively, a code having a mode other than those may be used, as long as it is a code from which data can be optically read. Further, a structure can be employed in which a plurality of converters 113 which each use different algorithms for converting data are provided, and the type of code displayed in the display device is changed.

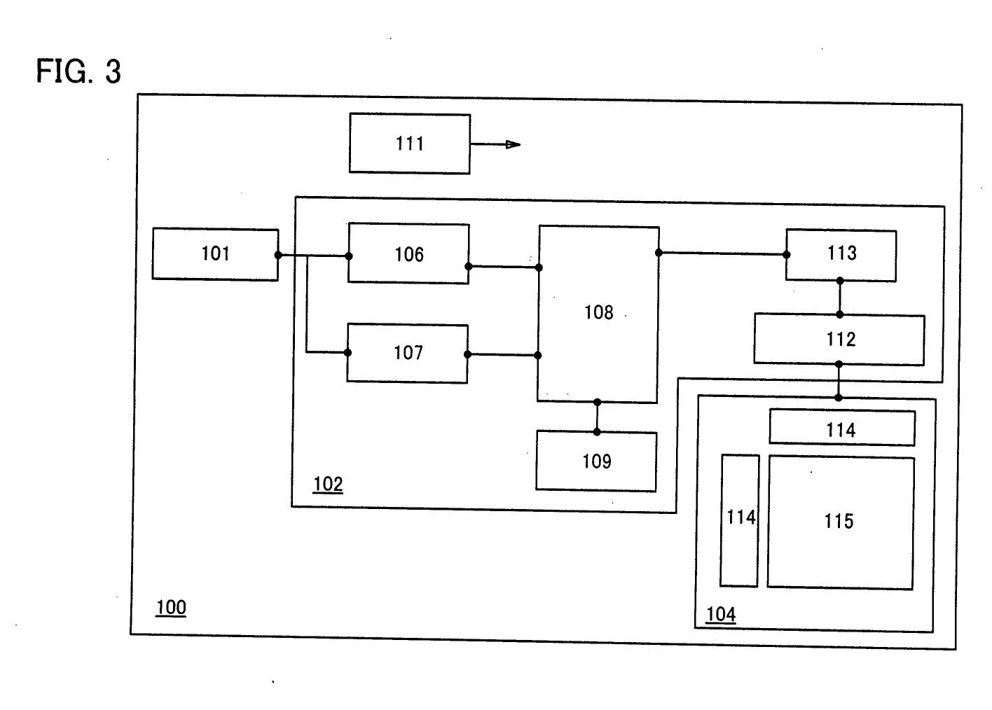

Note that although a memory carrier structure which employs the storage battery 103 is shown in FIG. 2, the invention is not limited to that structure. A primary battery may be used instead of a storage battery. FIG. 3 is a block diagram which shows a mode of a memory carrier of the invention which employs a primary battery. In FIG. 3, components which are the same as those in FIG. 2 are denoted by the same reference numerals as those used in FIG. 2.

The memory carrier 100 shown in FIG. 3 includes the antenna circuit 101, the integrated circuit 102, a primary battery 111, and the display device 104. The integrated circuit 102 includes the demodulation circuit 106, the modulation circuit 107, the control circuit 108, the memory 109, the image signal generating circuit 112, and the converter 113. Further, the display device 104 includes the driver circuits 114 and the pixel portion 115. In the memory carrier 100 shown in FIG. 3, a power supply voltage is supplied from the primary battery 111 to various circuits in the integrated circuit 102, such as the demodulation circuit 106, the modulation circuit 107, the control circuit 108, the memory 109, the image signal generating circuit 112, and the converter 113, and to the display device 104.

Further, in the memory carriers 100 of the invention shown in FIGS. 2 and 3, display of the code in the display device 104 can be performed continuously, or display and non-display of the code can be switched by an instruction from the interrogator 120. In the case where a rewritable memory is used for the memory 109, the code displayed in the display device 104 can be changed to suit rewritten data.

Furthermore, when a display element having a memory property is used in a pixel in the pixel portion 115 in the memory carriers 100 of the invention shown in FIGS. 2 and 3, power is hardly consumed except for when rewriting is performed, and display of the code can be maintained for an extended period of time. Accordingly, even if a problem occurs, such as the memory 109 breaking and data being unable to be read; supply of the power supply voltage to the display device 104 being unable to be performed; or communication between the memory carrier 100 and the interrogator 120 being unable to be performed due to a malfunction of any of various circuits included in the integrated circuit 102, if the problem occurs after a code is displayed in the display device 104 even once, data can be optically read by a scanner or the like from the displayed code.

Note that wireless transmission and reception of a signal between either of the memory carriers 100 shown in FIGS. 2 and 3 and an interrogator is performed by modulating a signal which is used as a carrier signal (a carrier wave). The carrier varies according to a standard; for example, it may have a frequency of 125 kHz, 13.56 MHz, 950 MHz, 2.45 GHz, or the like. Further, a method of modulation also varies according to a standard; for example, it may be amplitude modulation, frequency modulation, phase modulation, or the like; however, any modulation method which conforms to the standard may be used. Further, a signal transmission method used for signal transmission between the interrogator 120 and the memory carrier 100 can be classified into various types depending on a wavelength of the carrier; for example, it can be an electromagnetic coupling method, an electromagnetic induction method, or a microwave method.

Further, in the memory carriers 100 shown in FIGS. 2 and 3, it is desirable that the memory 109 is a nonvolatile memory. However, in the case where data can be stored by continuously supplying the power supply voltage to the memory 109, a volatile memory may be used. As the memory 109, for example, an SRAM, a DRAM, a flash memory, an EEPROM, a FeRAM, or the like can be used.

FIGS. 2 and 3 show structures in which the memory carrier 100 includes the antenna circuit 101; however, the memory carrier of the invention does not necessarily have to include the antenna circuit 101. Note that it is assumed that the antenna circuit 101 includes an antenna and a capacitor which is connected in parallel to the antenna; however, depending on the type of antenna used, the capacitor does not necessarily have to be provided in the antenna circuit 101. Concerning the form of the antenna, any antenna which can receive signals wirelessly may be used. For example, a dipole antenna, a patch antenna, a loop antenna, a Yagi antenna, or the like can be used. The form of the antenna may be selected as appropriate to suit the wavelength of the carrier and the transmission method.

Further, FIGS. 2 and 3 show structures in which the memory carrier 100 includes only one antenna circuit 101; however, the invention is not limited to these structures. The memory carrier 100 may include two antenna circuits; an antenna circuit for receiving power and an antenna circuit for receiving signals. In a case where one antenna circuit is included; for example, when both supply of power and transmission of signals are performed using a radio wave of 950 MHz; there is a possibility that a large amount of power will be transmitted a long distance and interference of a reception operation of another piece of radio equipment will be caused. Therefore, concerning the supply of power, it is desirable that the frequency of the radio wave is decreased and the supply of power is performed at close range; however, in this case, the communication range necessarily becomes short. However, when two antenna circuits are included, the radio wave frequency used for supplying power and the radio wave frequency used for transmitting signals can be different. For example, when transmitting power, the radio wave frequency can be 13.56 MHz and an electromagnetic induction method can be used, and when transmitting a signal, the radio wave frequency can be 950 MHz and a radio wave method can be used. When different antenna circuits are used to suit functions in this manner, power can be supplied at close range and signals can be transmitted over a long distance.

Further, FIGS. 2 and 3 show structures in which the memory carrier is an active memory carrier which includes a battery; however, the invention is not limited to these structures. A memory carrier of the invention may be a passive memory carrier which does not include a battery and which uses only power transmitted wirelessly from the interrogator to perform operations. However, in the case where the memory 109 is volatile, it is more preferable that the memory carrier be an active memory carrier, because then power can be continuously supplied to the memory 109.

### Embodiment Mode 2

A structure of a memory carrier of the invention will be described with reference to FIG. 1B. FIG. 1B is a block diagram which schematically shows a mode of a memory carrier of the invention. A memory carrier 200 in FIG. 1B includes a memory 209 for storing data; an image signal memory 216 in which data obtained by converting data stored in the memory 209 in accordance with an algorithm is stored; a control circuit 208 which reads data from the image signal memory 216 in accordance with a signal transmitted wirelessly from an interrogator 220; an image signal generating circuit 212 which uses the read data to generate an image signal; and a display device 204 which uses the image signal to display a code.

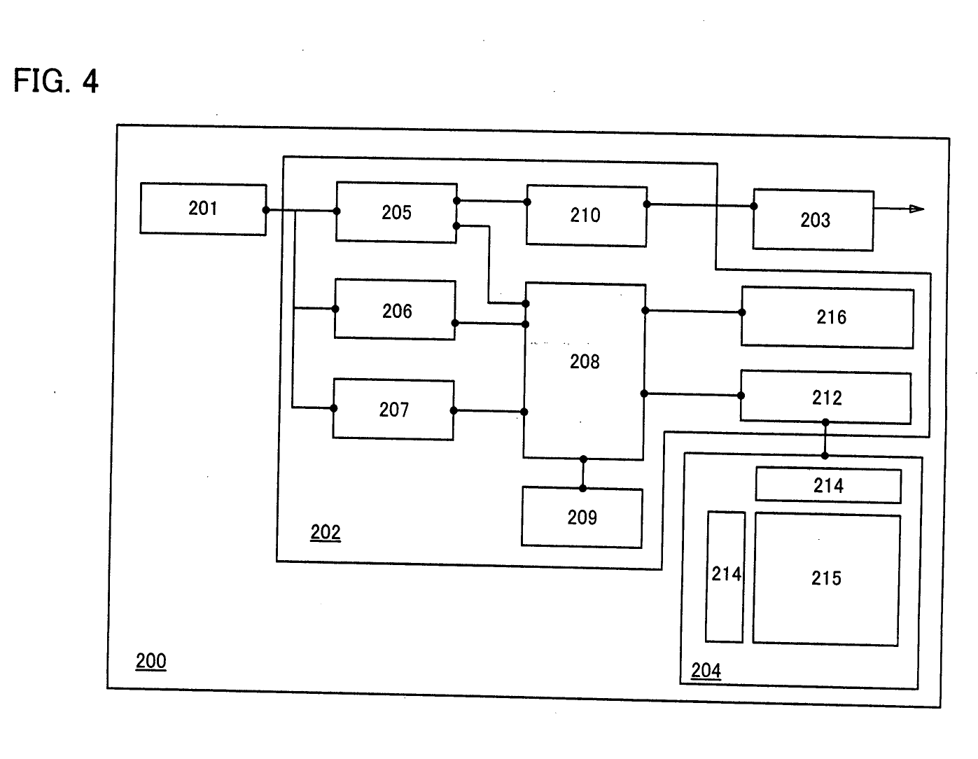

An example of a more specific structure of the memory carrier 200 shown in FIG. 1B is shown in FIG. 4. FIG. 4 is a block diagram which shows a mode of a memory carrier of the invention. The memory carrier 200 in FIG. 4 includes an antenna circuit 201, an integrated circuit 202, a storage battery 203, and the display device 204. The integrated circuit 202 includes a power supply circuit 205, a demodulation circuit 206, a modulation circuit 207, the control circuit 208, the memory 209, a charging circuit 210, the image signal generating circuit 212, and the image signal memory 216. The display device 204 includes driver circuits 214 and a pixel portion 215.

When a signal is transmitted wirelessly from the interrogator 220, similarly to in the case of Embodiment Mode 1, the signal is received in the antenna circuit 201, and a signal which includes an instruction from the interrogator 220 is generated. The demodulation circuit 206 demodulates the signal generated in the antenna circuit 201, and outputs the signal to the control circuit 208 of a subsequent stage. The control circuit 208 analyzes the signal inputted from the demodulation circuit 206, and reads data stored in the memory 209 in accordance with content of the instruction transmitted from the interrogator 220. Note that the control circuit 208 can perform arithmetic processing in accordance with the signal inputted from the demodulation circuit 206. When the arithmetic processing is performed, part of a region of the memory 209 or a separately provided memory can be used as a primary cache memory or a secondary cache memory.

A signal for output which includes data read from the memory 209 is encoded in the control circuit 208 and then transmitted to the modulation circuit 207. In accordance with that signal, the modulation circuit 207 modulates a wireless signal that is received by the antenna circuit 201. The modulated wireless signal is received by the interrogator 220. According to the above-described series of operations, data in the memory 209 included in the memory carrier 200 can be wirelessly transmitted to the interrogator 220. Accordingly, data of the memory carrier 200, such as identification information or the like, can be recognized.

Meanwhile, the power supply circuit 205 generates a power supply voltage by rectifying and smoothing a voltage of the signal received by the antenna circuit 201. The power supply voltage generated in the power supply circuit 205 is supplied to the control circuit 208 and the charging circuit 210. Note that alternatively, a structure may be employed in which after the signal received by the antenna circuit 201 has been rectified and smoothed, the voltage is stabilized by a voltage regulator circuit such as a regulator or the like and is then supplied to the control circuit 208 and the charging circuit 210 as a power supply voltage. The charging circuit 210 adjusts the level of the power supply voltage from the power supply circuit 205 and uses the adjusted voltage to charge the storage battery 203. Further, the power supply voltage generated in the power supply circuit 205 is supplied to various circuits in the integrated circuit 202, such as the demodulation circuit 206, the modulation circuit 207, the control circuit 208, the memory 209, the image signal generating circuit 212, and the image signal memory 216, and to the display device 204.

Note that a charge control circuit for controlling the power supply circuit 205 may be provided in the integrated circuit 202 so that excessive charging of the storage battery 203 is prevented. Further, the power supply circuit 205 can include a rectifier circuit, a smoothing capacitor, a regulator, a switching circuit, and the like. When a diode is used for the switching circuit, excessive charging of the storage battery 203 can be suppressed without using a charge control circuit.

Further, in the memory carrier 200 of the invention, image signal data obtained by converting data stored in the memory 209 in accordance with a predetermined algorithm is stored in the image signal memory 216. The data stored in the image signal memory 216 is read by the control circuit 208 in accordance with an instruction from the interrogator 220 and is output as an image signal to the image signal generating circuit 212. The image signal generating circuit 212 performs signal processing on the inputted image signal to suit specifications of the display device 204, and inputs the image signal to the display device 204.

In the display device 204, when the driver circuits 214 control operation of the pixel portion 215 in accordance with the inputted image signal, a code which corresponds to data stored in the memory 209 is displayed in the pixel portion 215. Data can be optically read by a scanner or the like from the code displayed in the pixel portion 215.

Note that the displayed code may be a one-dimensional code (a bar code) or a two-dimensional code. Alternatively, a code having a mode other than those may be used, as long as it is a code from which data can be optically read. Further, a structure can be employed in which a plurality of image signal data, each data of which is converted using a different algorithm, are stored in the image signal memory 216, so that the type of code displayed in the display device may be changed. In that case, the plurality of data may be stored in separate regions within a single image signal memory 216, or the plurality of data may be stored using a plurality of image signal memories 216.

Further, FIG. 4 shows a structure of the memory carrier 200 which includes the memory 209 and the image signal memory 216; however, the invention is not limited to this structure. A structure can be employed in which the image signal memory 216 is not provided, and data that would have been stored in the image signal memory 216 is also stored in the memory 209.

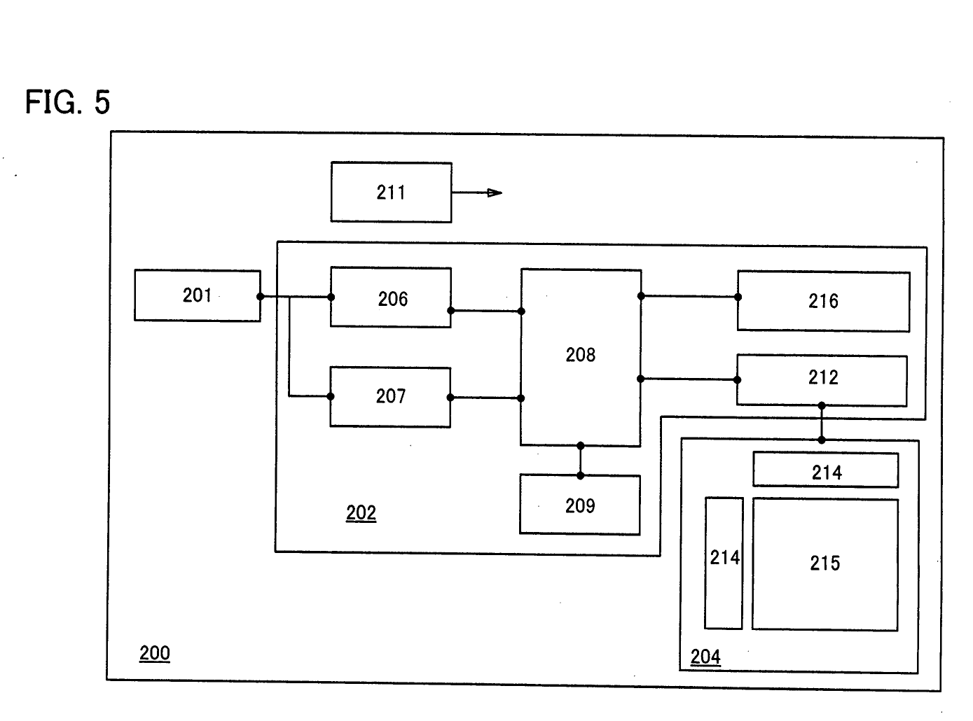

Further, although a memory carrier structure which employs the storage battery 203 is shown in FIG. 4, the invention is not limited to this structure. A primary battery may be used instead of a storage battery. FIG. 5 is a block diagram which shows a mode of a memory carrier of the invention which employs a primary battery. In FIG. 5, components which are the same as those shown in FIG. 4 are denoted by the same reference numerals as those used in FIG. 4.

The memory carrier 200 shown in FIG. 5 includes the antenna circuit 201, the integrated circuit 202, a primary battery 211, and the display device 204. The integrated circuit 202 includes the demodulation circuit 206, the modulation circuit 207, the control circuit 208, the memory 209, the image signal generating circuit 212, and the image signal memory 216. Further, the display device 204 includes the driver circuits 214 and the pixel portion 215. In the memory carrier 200 shown in FIG. 5, a power supply voltage is supplied from the primary battery 211 to various circuits in the integrated circuit 202, such as the demodulation circuit 206, the modulation circuit 207, the control circuit 208, the memory 209, the image signal generating circuit 212, and the image signal memory 216, and to the display device 204.

Further, in the memory carriers 200 of the invention shown in FIGS. 4 and 5, display of the code in the display device 204 can be performed continuously, or display and non-display of the code can be switched by an instruction from the interrogator 220. In the case where rewritable memories are used for the memory 209 and the image signal memory 216, the code displayed in the display device 204 can be changed to suit the rewritten data.

Furthermore, when a display element having a memory property is used in a pixel in the pixel portion 215 in the memory carriers 200 of the invention shown in FIGS. 4 and 5, power is hardly consumed except for when rewriting is performed, and display of the code can be maintained for an extended period of time. Accordingly, even if a problem occurs, such as the memory 209 or the image signal memory 216 breaking, resulting in data being unable to be read; supply of power supply voltage to the display device 204 being unable to be performed; or communication between the memory carrier 200 and the interrogator 220 being unable to be performed due a malfunction of any of various circuits included in the integrated circuit 202, if the problem occurs after a code is displayed in the display device 204 even once, data can be optically read by a scanner or the like from the displayed code.

Note that wireless transmission and reception of a signal between either of the memory carriers 200 shown in FIGS. 4 and 5 and an interrogator is performed by modulating a signal which is used as a carrier signal (a carrier wave). The carrier varies according to a standard; for example, it may have a frequency of 125 kHz, 13.56 MHz, 950 MHz, 2.45 GHz, or the like. Further, a method of modulation also varies according to a standard; for example, it may be amplitude modulation, frequency modulation, phase modulation, or the like; however, any modulation method which conforms to the standard may be used. Further, a signal transmission method used for signal transmission between the interrogator 220 and the memory carrier 200 can be classified into various types depending on a wavelength of the carrier; for example, it can be an electromagnetic coupling method, an electromagnetic induction method, or a microwave method.

Further, in the memory carriers 200 shown in FIGS. 4 and 5, it is desirable that the memory 209 or the image signal memory 216 is a nonvolatile memory. However, in the case where data can be stored by continuously supplying the power supply voltage to the memory 209 or the image signal memory 216, a volatile memory may be used. As the memory 209 or the image signal memory 216, for example, an SRAM, a DRAM, a flash memory, an EEPROM, a FeRAM, or the like can be used.

FIGS. 4 and 5 show structures of the memory carrier 200 which include the antenna circuit 201; however, the memory carrier of the invention does not necessarily have to include the antenna circuit 201. Note that it is assumed that the antenna circuit 201 includes an antenna and a capacitor which is connected in parallel to the antenna; however, depending on the type of antenna used, the capacitor does not necessarily have to be provided in the antenna circuit 201. Concerning the form of the antenna, any antenna which can receive signals wirelessly may be used. For example, a dipole antenna, a patch antenna, a loop antenna, a Yagi antenna, or the like can be used. The form of the antenna may be selected as appropriate to suit the wavelength of the carrier and the transmission method.

Further, FIGS. 4 and 5 show structures of the memory carrier 200 which include only one antenna circuit 201; however, the invention is not limited to these structures. The memory carrier 200 may include two antenna circuits; an antenna circuit for receiving power and an antenna circuit for receiving signals. In a case where one antenna circuit is included; for example, when both supply of power and transmission of signals are performed using a radio wave of 950 MHz; there is a possibility that a large amount of power will be transmitted a long distance and interference of a reception operation of another piece of radio equipment will be caused. Therefore, concerning the supply of power, it is desirable that the frequency of the radio wave is decreased and the supply of power is performed at close range; however, in this case, the communication range necessarily becomes short. However, when two antenna circuits are included, the radio wave frequency used for supplying power and the radio wave frequency used for transmitting signals can be different. For example, when transmitting power, the radio wave frequency can be 13.56 MHz and an electromagnetic induction method can be used, and when transmitting a signal, the radio wave frequency can be 950 MHz and a radio wave method can be used. When different antenna circuits are used to suit functions in this manner, power can be supplied at close range and signals can be transmitted over a long distance.

Further, FIGS. 4 and 5 show structures in which the memory carrier 200 is an active memory carrier which includes a battery; however, the invention is not limited to these structures. A memory carrier of the invention may be a passive memory carrier which does not include a battery and which uses only power transmitted wirelessly from the interrogator to perform operations. However, in the case where the memory 209 is volatile, it is more preferable that the memory carrier be an active memory carrier, because then power can be continuously supplied to the memory 209.

This embodiment mode can be combined with Embodiment Mode 1.

### Embodiment Mode 3

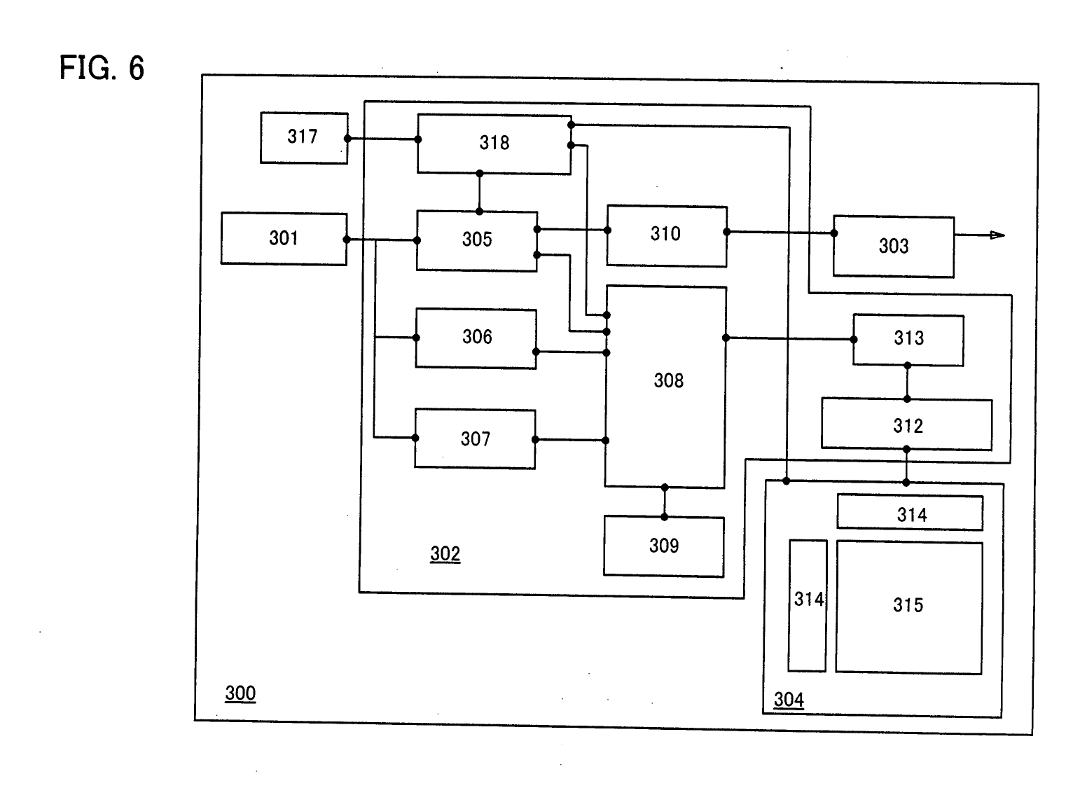

A structure of a memory carrier of the invention will be described with reference to FIG. 6. FIG. 6 is a block diagram which shows a mode of a memory carrier of the invention. A memory carrier 300 in FIG. 6 includes an antenna circuit 301, an integrated circuit 302, a storage battery 303, a display device 304, and a terminal 317. The integrated circuit 302 includes a power supply circuit 305, a demodulation circuit 306, a modulation circuit 307, a control circuit 308, a memory 309, a charging circuit 310, an image signal generating circuit 312, a converter 313, and an interface 318. The display device 304 includes driver circuits 314 and a pixel portion 315.

When a signal is transmitted wirelessly from an interrogator, similarly to in Embodiment Mode 1, the signal is received in the antenna circuit 301, and a signal which includes an instruction from the interrogator is generated. The demodulation circuit 306 demodulates the signal generated in the antenna circuit 301, and outputs the signal to the control circuit 308 of a subsequent stage. The control circuit 308 analyzes the signal inputted from the demodulation circuit 306, and reads data stored in the memory 309 in accordance with content of the instruction transmitted from the interrogator. Note that the control circuit 308 can perform arithmetic processing in accordance with the signal input from the demodulation circuit 306. When the arithmetic processing is performed, part of a region of the memory 309 or a separately provided memory can be used as a primary cache memory or a secondary cache memory.

A signal for output which includes data read from the memory 309 is encoded in the control circuit 308 and then transmitted to the modulation circuit 307. In accordance with that signal, the modulation circuit 307 modulates a wireless signal that is received by the antenna circuit 301. The modulated wireless signal is received by the interrogator. According to the above-described series of operations, data in the memory 309 can be wirelessly transmitted to the interrogator from the memory carrier 300. Accordingly, data of the memory carrier 300, such as identification information or the like, can be recognized.

Further, the memory carrier 300 of this embodiment mode can also directly connect with the interrogator using the terminal 317. When a signal is input from the terminal 317, that signal undergoes signal processing in the interface 318, such as adjustment of amplitude of a voltage, shaping of a waveform, or the like, and is input to various circuits in the integrated circuit 302 and to the display device 304 and the like. Further, a signal for output can be transmitted to the interrogator from the integrated circuit 302 via the interface 318 and the terminal 317. When the terminal 317 and the interface 318 are provided, communication with the interrogator can be performed even in the case where wireless transmission and reception of a signal is not possible.

Meanwhile, the power supply circuit 305 generates a power supply voltage by rectifying and smoothing a voltage of the signal received by the antenna circuit 301. The power supply voltage generated in the power supply circuit 305 is supplied to the control circuit 308 and the charging circuit 310. Note that alternatively, a structure may be employed in which after the signal received by the antenna circuit 301 is rectified and smoothed, the voltage is stabilized by a voltage regulator circuit such as a regulator or the like and is then supplied to the control circuit 308 and the charging circuit 310 as a power supply voltage. The charging circuit 310 adjusts the level of the power supply voltage from the power supply circuit 305 and uses the adjusted voltage to charge the storage battery 303. Further, the power supply voltage generated in the power supply circuit 305 is supplied to various circuits in the integrated circuit 302, such as the demodulation circuit 306, the modulation circuit 307, the control circuit 308, the memory 309, the image signal generating circuit 312, the converter 313, and the interface 318, and to the display device 304.

Note that a charge control circuit for controlling the power supply circuit 305 may be provided in the integrated circuit 302 so that excessive charging of the storage battery 303 is prevented. Further, the power supply circuit 305 can include a rectifier circuit, a smoothing capacitor, a regulator, a switching circuit, and the like. When a diode is used for the switching circuit, excessive charging of the storage battery 303 can be suppressed without using a charge control circuit.

Note that in this embodiment mode, the power supply voltage can be directly supplied to the power supply circuit 305 and the display device 304 via the terminal 317 and the interface 318. Therefore, power can be supplied to the memory carrier 300 even in the case where it is not possible to supply power wirelessly.

Further, in the memory carrier 300 of the invention, data stored in the memory 309 is read by the control circuit 308 in accordance with a signal from the demodulation circuit 306, and transmitted to the converter 313. The converter 313 generates an image signal for displaying a code by converting the inputted data in accordance with a predetermined algorithm, and outputs the image signal to the image signal generating circuit 312. The algorithm may be stored in the memory 309, or in a separately prepared memory. The converter 313 converts the data using the algorithm which has been read from the memory 309 by the control circuit 308. Alternatively, a structure in which the algorithm is input to the memory carrier 300 from the terminal 317 may be used. The image signal generating circuit 312 performs signal processing on the inputted image signal to suit specifications of the display device 304, and inputs the image signal to the display device 304.

In the display device 304, when the driver circuits 314 control operation of the pixel portion 315 in accordance with the inputted image signal, a code which corresponds to data stored in the memory 309 is displayed in the pixel portion 315. Data can be optically read by a scanner or the like from the code displayed in the pixel portion 315.

Further, the displayed code may be a one-dimensional code (a bar code) or a two-dimensional code. Alternatively, a code having a mode other than those may be used, as long as it is a code from which data can be optically read. Further, a structure can be employed in which a plurality of converters 313 which each use different algorithms for converting data are provided, and the type of code displayed in the display device 304 is changed.

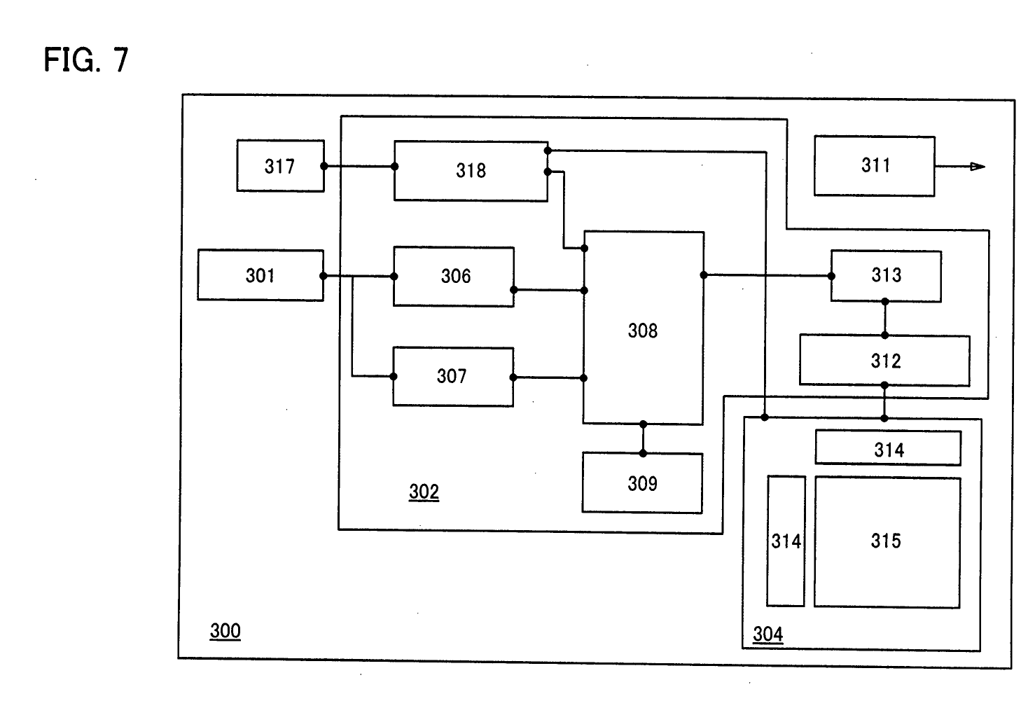

Note that although a memory carrier structure which employs the storage battery 303 is shown in FIG. 6, the invention is not limited to that structure. A primary battery may be used instead of the storage battery 303. FIG. 7 is a block diagram which shows a mode of a memory carrier of the invention which employs a primary battery. In FIG. 7, components which are the same as those in FIG. 6 are denoted by the same reference numerals as those used in FIG. 6.

The memory carrier 300 shown in FIG. 7 includes the antenna circuit 301, the integrated circuit 302, a primary battery 311, the display device 304, and the terminal 317. The integrated circuit 302 includes the demodulation circuit 306, the modulation circuit 307, the control circuit 308, the memory 309, the image signal generating circuit 312, the converter 313, and the interface 318. Further, the display device 304 includes the driver circuits 314 and the pixel portion 315. In the memory carrier 300 shown in FIG. 7, a power supply voltage is supplied from the primary battery 311 to various circuits in the integrated circuit 302, such as the demodulation circuit 306, the modulation circuit 307, the control circuit 308, the memory 309, the image signal generating circuit 312, the converter 313, and the interface 318, and to the display device 304.

Further, in the memory carriers 300 of the invention shown in FIGS. 6 and 7, display of the code in the display device 304 can be performed continuously, or display and non-display of the code can be switched by an instruction from the interrogator. In the case where a rewritable memory is used for the memory 309, the code displayed in the display device 304 can be changed to suit rewritten data.

Furthermore, when a display element having a memory property is used in a pixel in the pixel portion 315 in the memory carriers 300 of the invention shown in FIGS. 6 and 7, power is hardly consumed except for when rewriting is performed, and display of the code can be maintained for an extended period of time. Accordingly, even if a problem occurs, such as the memory 309 breaking and data being unable to be read; supply of the power supply voltage to the display device 304 being unable to be performed; or communication between the memory carrier 300 and the interrogator 320 being unable to be performed due to a malfunction of any of various circuits included in the integrated circuit 302, if the problem occurs after a code is displayed in the display device 304 even once, data can be optically read by a scanner or the like from the displayed code.

Note that wireless transmission and reception of a signal between either of the memory carriers 300 shown in FIGS. 6 and 7 and the interrogator is performed by modulating a signal which is used as a carrier signal (a carrier wave). The carrier varies according to a standard; for example, it may have a frequency of 125 kHz, 13.56 MHz, 950 MHz, 2.45 GHz, or the like. Further, a method of modulation also varies according to a standard; for example, it may be amplitude modulation, frequency modulation, phase modulation, or the like; however, any modulation method which conforms to the standard may be used. Further, a signal transmission method used for signal transmission between the interrogator and the memory carrier 300 can be classified into various types depending on a wavelength of the carrier; for example, it can be an electromagnetic coupling method, an electromagnetic induction method, or a microwave method.

Further, in the memory carriers 300 shown in FIGS. 6 and 7, it is desirable that the memory 309 is a nonvolatile memory. However, in the case where data can be stored by continuously supplying the power supply voltage to the memory 309, a volatile memory may be used. As the memory 309, for example, an SRAM, a DRAM, a flash memory, an EEPROM, a FeRAM, or the like can be used.

FIGS. 6 and 7 show structures in which the memory carrier 300 includes the antenna circuit 301; however, the memory carrier of the invention does not necessarily have to include the antenna circuit 301. Note that it is assumed that the antenna circuit 301 includes an antenna and a capacitor which is connected in parallel to the antenna; however, depending on the type of antenna used, the capacitor does not necessarily have to be provided in the antenna circuit 301. Concerning the form of the antenna, any antenna which can receive signals wirelessly may be used. For example, a dipole antenna, a patch antenna, a loop antenna, a Yagi antenna, or the like can be used. The form of the antenna may be selected as appropriate to suit the wavelength of the carrier and the transmission method.

Further, FIGS. 6 and 7 show structures in which the memory carrier 300 includes only one antenna circuit 301; however, the invention is not limited to these structures. The memory carrier 300 may include two antenna circuits; an antenna circuit for receiving power and an antenna circuit for receiving signals. In a case where one antenna circuit is included; for example, when both supply of power and transmission of signals are performed using a radio wave of 950 MHz; there is a possibility that a large amount of power will be transmitted a long distance and interference of a reception operation of another piece of radio equipment will be caused. Therefore, concerning the supply of power, it is desirable that the frequency of the radio wave is decreased and the supply of power is performed at close range; however, in this case, the communication range necessarily becomes short. However, when two antenna circuits are included, the radio wave frequency used for supplying power and the radio wave frequency used for transmitting signals can be different. For example, when transmitting power, the radio wave frequency can be 13.56 MHz and an electromagnetic induction method can be used, and when transmitting a signal, the radio wave frequency can be 950 MHz and a radio wave method can be used. When different antenna circuits are used to suit functions in this manner, power can be supplied at close range and signals can be transmitted over a long distance.

Further, FIGS. 6 and 7 show structures in which the memory carrier is an active memory carrier which includes a battery; however, the invention is not limited to these structures. A memory carrier of the invention may be a passive memory carrier which does not include a battery and which uses only power transmitted wirelessly from the interrogator to perform operations. However, in the case where the memory 309 is volatile, it is more preferable that the memory carrier be an active memory carrier, because then power can be continuously supplied to the memory 309.

This embodiment mode can be combined with the either of the above-described embodiment modes.

### Embodiment 1

In this embodiment, an outside appearance of a memory carrier of the invention and a specific structure of an inside of the memory carrier of the invention will be described.

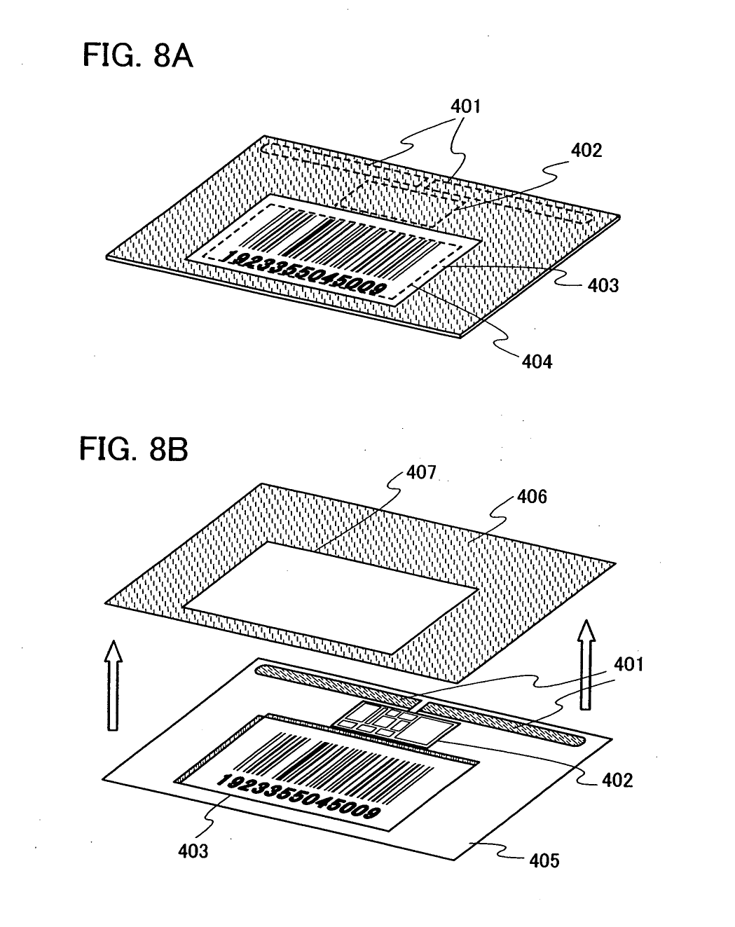

FIG. 8A shows a perspective view of an example of a memory carrier of the invention. The memory carrier shown in FIG. 8A includes antenna circuits 401, an integrated circuit 402, and a display device 403. FIG. 8A shows an example in which a one-dimensional code 404 is displayed in a pixel portion of the display device 403.

Further, FIG. 8B shows a view of the memory carrier in FIG. 8A in which a cover material 406 has been removed from a substrate 405. The antenna circuits 401 and the integrated circuit 402 are provided over the substrate 405, and are interposed between the substrate 405 and the cover material 406. Further, the display device 403 is provided over the substrate 405 together with the antenna circuits 401 and the integrated circuit 402.

In the memory carrier, the antenna circuits 401 may be formed over the substrate 405 together with the integrated circuit 402, or the antenna circuits 401 may be separately provided and the integrated circuit 402 which is formed over the substrate 405 may be connected to the separately provided antenna circuits 401. Further, the display device 403 can be formed over the substrate 405, together with the integrated circuit 402.

Note that in the memory carrier shown in FIGS. 8A and 8B, the cover material 406 has an opening portion 407 in a region which overlaps with the display device 403. When the display device 403 is exposed in the opening portion 407, a code displayed in the display device 403 can be read by a scanner. Note that the cover material 406 does not necessarily have the opening portion 407. For example, when the cover material 406 is light-transmitting in at least the region which overlaps with the display device 403, even if the entire display device 403 is covered by the cover material 406, a code displayed in the display device 403 can be read by a scanner.

Note that the form of an antenna included in the antenna circuits 401 is not limited to the form of a dipole antenna shown in this embodiment. The antenna may have any form which enables it to receive signals wirelessly. For example, as an alternative to a dipole antenna, a patch antenna, a loop antenna, a Yagi antenna, or the like can be used. The form of the antenna may be selected as appropriate to suit the wavelength of a carrier and a transmission method.

This embodiment can be combined with any of the above-described embodiment modes.

### Embodiment 2

In this embodiment, an example of a more specific structure of a passive matrix display device included in a memory carrier of the invention will be described.

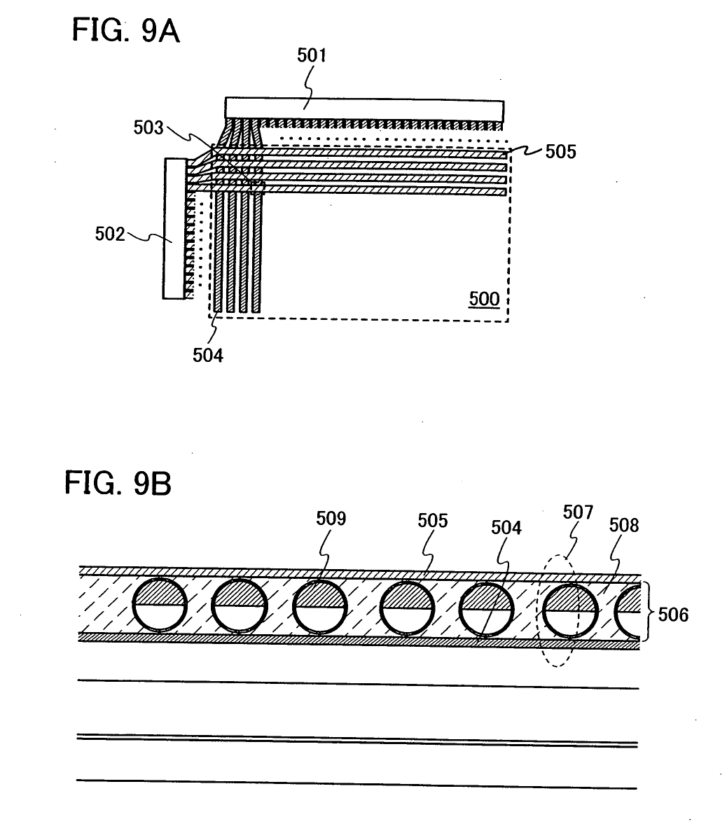

FIG. 9A shows a top view of a pixel portion 500, a first electrode driver circuit 501, and a second electrode driver circuit 502 of the display device which is included in a memory carrier of the invention. In FIG. 9A, the first electrode driver circuit 501 and the second electrode driver circuit 502 are provided on the periphery of the pixel portion 500. The pixel portion 500 includes a plurality of pixels 503, and a display element is provided in each pixel 503. Further, FIG. 9B shows a cross-sectional view of display elements which are provided in the pixels 503.

A display element 507 includes a first electrode 504 to which a voltage of an image signal is applied by the first electrode driver circuit 501; a second electrode 505 which is selected by the second electrode driver circuit 502; and a display material 506 to which a voltage is applied by the first electrode 504 and the second electrode 505.

Note that although a structure of the display element 507 in which the display material 506 is included between the first electrode 504 and the second electrode 505 is shown in this embodiment, the invention is not limited to this structure. A display element which includes a display material provided over a first electrode and a second electrode between which an insulating film is interposed may be employed. Note that in that case, the second electrode, the insulating film, the first electrode, an insulating film which reflects light, and the display material are stacked in that order. Further, the first electrode is formed in sections, such that a region in which of the second electrode and the first electrode, only the second electrode overlaps with the display material is formed, and a region in which the display material overlaps with both the first electrode and the second electrode is formed; and for the display material, a display material in which charged fine particles are dispersed in a solvent is used.

Further, in FIG. 9B, as the display material 506, a solvent 508 and twisting balls 509 which are dispersed in the solvent 508 are used. In accordance with a voltage of an image signal which is applied by the first electrode, the dichromic twisting balls 509, whose hemispheres are different colors to each other and charge differently, turn round in the solvent 508, and thus display with two values of gray scale can be performed. Note that the display material which can be used in this embodiment is not limited to this.

Note that although description is made with reference to an example in which the display element employs a display material having a memory property in this embodiment, the display element which can be used in the invention is not limited to this structure. For the memory carrier of the invention, a light-emitting element typified by an organic light-emitting element (an OLED), a liquid crystal element, or the like can also be used.

This embodiment can be combined with any one of the above-described embodiment modes and embodiment.

### Embodiment 3

In this embodiment, an example of a more specific structure of an active matrix display device included in a memory carrier of the invention will be described.

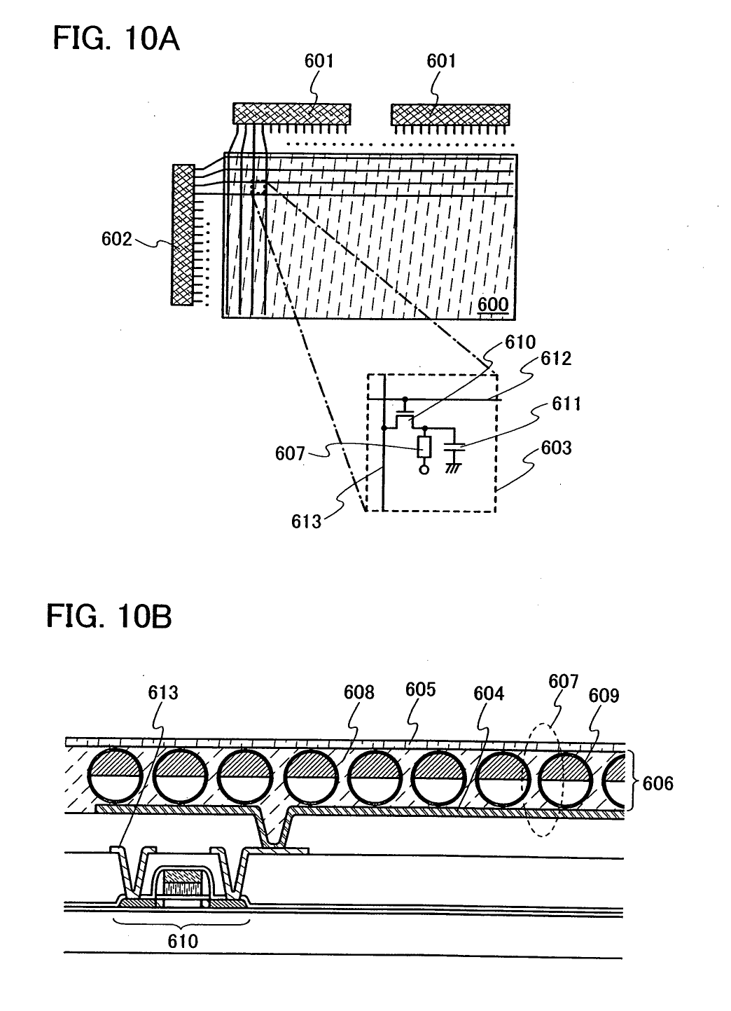

FIG. 10A shows a top view of a pixel portion 600, signal line driver circuits 601, and a scanning line driver circuit 602 of a display device included in a memory carrier of the invention. In FIG. 10A, the signal line driver circuits 601 and the scanning line driver circuit 602 are provided on the periphery of the pixel portion 600. The pixel portion 600 includes a plurality of pixels 603.

The pixel 603 includes a transistor 610, a display element 607, and a storage capacitor 611. FIG. 10B shows a cross-sectional view of the display element 607 provided in each pixel 603. The display element 607 includes a first electrode 604, a second electrode 605, and a display material 606 to which a voltage is applied by the first electrode 604 and the second electrode 605. A gate electrode of the transistor 610 is connected to a scanning line 612 which is selected by the scanning line driver circuit 602. Further, concerning a source region and a drain region of the transistor 610, one is directly or electrically connected to a signal line 613 to which a voltage of an image signal is applied from the signal line driver circuit 601, and the other is directly or electrically connected to the first electrode 604 of the display element 607.

Note that in FIG. 10A, the storage capacitor 611 is connected in parallel to the display element 607 so that a voltage applied between the first electrode 604 and the second electrode 605 of the display element 607 is stored; however, in the case where the memory property of the display material 606 is sufficiently high that display can be maintained, the storage capacitor 611 is not necessarily provided.

Note that although a structure of the display element 607 in which the display material 606 is included between the first electrode 604 and the second electrode 605 is shown in this embodiment, the invention is not limited to this structure. A display element which includes a display material provided over a first electrode and a second electrode between which an insulating film is interposed may be employed. Note that in that case, the second electrode, the insulating film, the first electrode, an insulating film which reflects light, and the display material are stacked in that order. Further, the first electrode is formed in sections, such that a region in which of the second electrode and the first electrode, only the second electrode overlaps with the display material is formed, and a region in which the display material overlaps with both the first electrode and the second electrode is formed; and for the display material, a display material in which charged fine particles are dispersed in a solvent is used.

Further, in FIG 10B, as the display material 606, a solvent 608 and twisting balls 609 which are dispersed in the solvent 608 are used. In accordance with a voltage of an image signal which is applied by the first electrode 604, the dichromic twisting balls 609, whose hemispheres are different colors to each other and charge differently, turn round in the solvent 608, and thus display with two values of gray scale can be performed. Note that the display material which can be used in this embodiment is not limited to this.

Further, the form of the transistor 610 is not limited to the mode shown in FIG. 10B. For example, as the transistor 610, a bottom-gate transistor in which a gate electrode is provided between a substrate and an active layer may be employed.

Note that although an active matrix pixel portion structure in which one transistor which serves as a switching element is provided in each pixel is described in this embodiment, the invention is not limited to this structure. A plurality of transistors may be provided in each pixel. Further, besides transistors, elements such as capacitors, resistors, coils, or the like may also be provided in the pixels.

Note that although description is made with reference to an example in which the display element employs a display material having a memory property in this embodiment, the display element which can be used in the invention is not limited to this structure. For the memory carrier of the invention, a light-emitting element typified by an organic light-emitting element (an OLED), a liquid crystal element, or the like can also be used.

This embodiment can be combined with any one of the above-described embodiment modes and embodiments.

### Embodiment 4

In this embodiment, types of symbol displayed in a pixel portion and a structure of the pixel portion will be described.

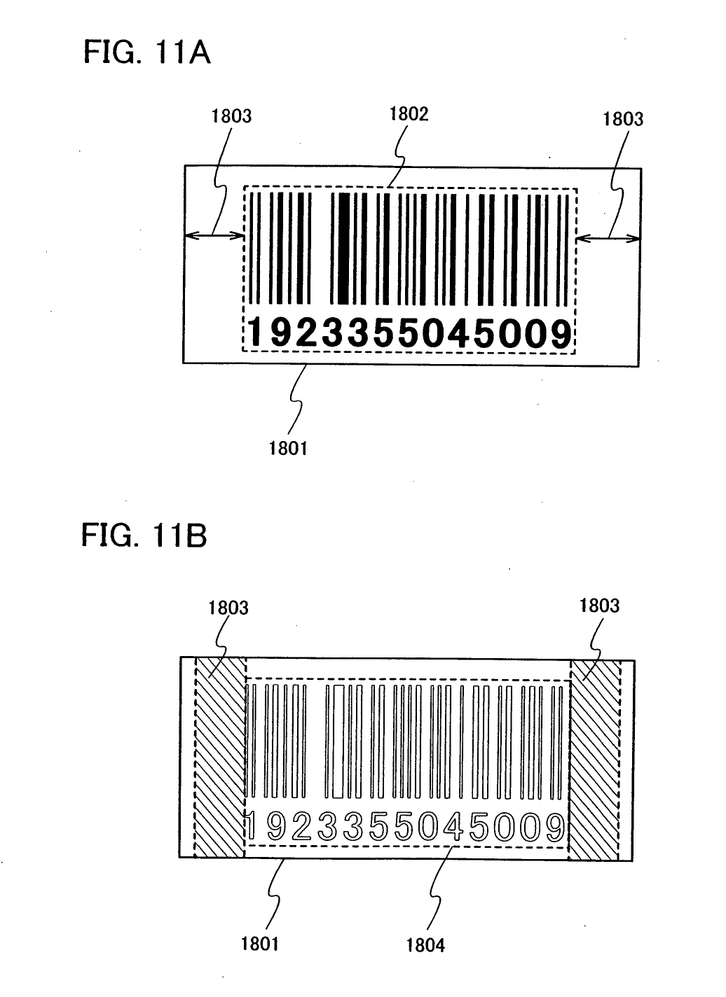

FIG. 11A shows a view of a pixel portion 1801 displaying a one-dimensional code. The one-dimensional code includes a symbol 1802 for displaying information, and margins 1803 provided on the right and left of the symbol 1802. The symbol 1802 varies depending on information included in the one-dimensional code or a standard of the one-dimensional code; however, basically, it has a structure in which a plurality of bars and spaces are lined up in order. Further, as shown in FIG. 11A, below a region in which the bars and spaces are lined up, figures may be displayed.

The margins 1803 are regions of space provided so that the one-dimensional code is read. The margins 1803 vary depending on standards; however, it is desirable that margins which have a width greater than or equal to ten times the width of the thinnest bar of the bars included in the symbol 1802 be provided on the right and the left of the symbol 1802. In the case where a width of the margins 1803 of a one-dimensional code displayed in the pixel portion 1801 is fixed, it is also possible to not dispose pixels in regions of the pixel portion 1801 which are to be used as the margins 1803.

FIG. 11B shows a region (a pixel disposal region) 1804 in which pixels are disposed which is in the pixel portion 1801, in the case where a one-dimensional code for which a width of the margins 1803 is fixed in advance is displayed. The symbol 1802 can be displayed in the pixel disposal region 1804. The pixel disposal region 1804 is disposed between the pair of margins 1803.

Note that although FIG. 11B shows an example in which pixels are only disposed in a region in which the symbol 1802 is displayed and are not disposed in regions which form the margins 1803, the invention is not limited to this structure. A structure in which pixels are also disposed in the regions which form the margins 1803, and the regions which are the margins 1803 are formed using an image signal may be employed.

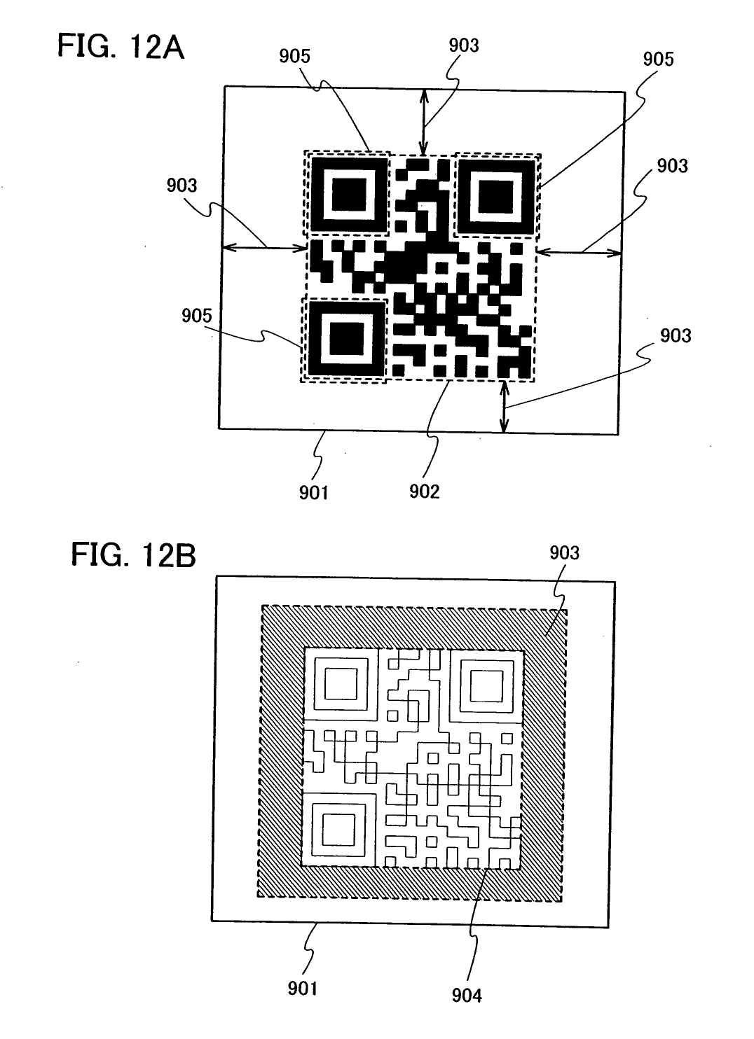

FIG. 12A shows a view of a pixel portion 901 in which a two-dimensional code is displayed. The two-dimensional code includes a symbol 902 for displaying information, and margins 903 which are provided above and below and on the right and left of the symbol 902. The symbol 902 varies depending on information included in the two-dimensional code or a standard of the two-dimensional code; however, basically, it has a structure in which a plurality of cells and spaces are disposed. Further, as shown in FIG. 12A, cut-out symbols 905 may be displayed within the symbol 902 so that data can be read regardless of the direction in which the symbol 902 is disposed.

The margins 903 are regions of space provided so that the two-dimensional code is read. The margins 903 vary depending on standards; however, it is desirable that margins which have a width greater than or equal to four times the width of a cell included in the symbol 902 be provided above and below and on the right and the left of the symbol 902. In the case where a width of the margins 903 of the two-dimensional code displayed in the pixel portion 901 is fixed, it is also possible to not dispose pixels in regions of the pixel portion 901 which are to be used as the margins 903.

FIG. 12B shows a region (a pixel disposal region) 904 in which pixels are disposed which is in the pixel portion 901, in the case where a two-dimensional code for which a width of the margins 903 is fixed in advance is displayed. The symbol 902 can be displayed in the pixel disposal region 904. The pixel disposal region 904 is surrounded by the margins 903, which are above, below, and on the right and left of the pixel disposal region 904.

Note that although FIG. 12B shows an example in which pixels are only disposed in a region in which the symbol 902 is displayed and are not disposed in regions which form the margins 903, the invention is not limited to this structure. A structure in which pixels are also disposed in the regions which form the margins 903, and the regions which are the margins 903 are formed by an image signal may be employed.

This embodiment can be combined with any one of the above-described embodiment modes or embodiments.

### Embodiment 5

A method of manufacturing a memory carrier of the invention will now be described in detail. Note that although a thin film transistor (TFT) is used as an example of a semiconductor element in this embodiment, a semiconductor element which can be used in the memory carrier of the invention is not limited thereto. For example, besides a TFT, a memory element, a diode, a resistor, a capacitor, an inductor, or the like can be used.

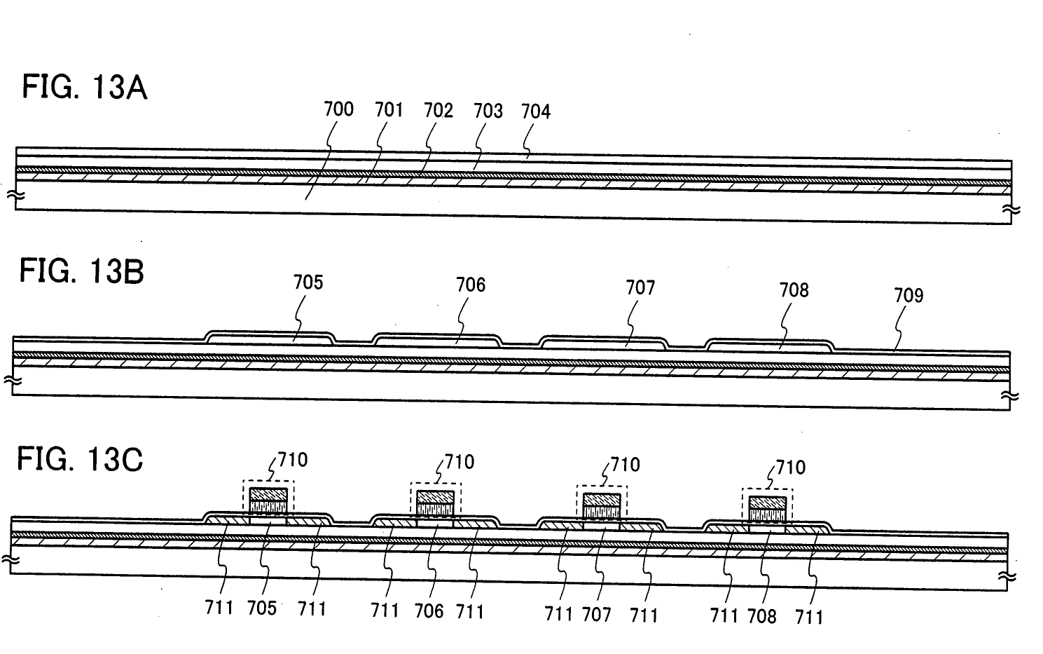

First, as shown in FIG. 13A, an insulating film 701, a separation layer 702, an insulating film 703, and a semiconductor film 704 are formed in that order over a substrate 700 having heat resistance. The insulating film 701, the separation layer 702, the insulating film 703, and the semiconductor film 704 can be formed in succession.

As the substrate 700, a glass substrate made from barium borosilicate glass, alumino borosilicate glass, or the like; a quartz substrate; a ceramic substrate; or the like can be used, for example. Alternatively, a metal substrate, such as a stainless steel substrate, or a semiconductor substrate, such as a silicon substrate, may be used. A substrate formed from a synthetic resin which has flexibility, such as plastic or the like, generally tends to have a lower allowable temperature limit than the above-mentioned substrates, but can be used as long as it can withstand processing temperatures of the manufacturing process.

As a plastic substrate, a substrate formed from polyester, typified by polyethylene terephthalate (PET); polyether sulfone (PES); polyethylene naphthalate (PEN); polycarbonate (PC); nylon; polyether etherketone (PEEK); polysulfone (PSF); polyether imide (PEI); polyarylate (PAR); polybutylene terephthalate (PBT); polyimide; an acrylonitrile butadiene styrene resin; poly vinyl chloride; polypropylene; poly vinyl acetate; an acrylic resin; or the like can be used.

Note that although the separation layer 702 is provided over an entire upper surface of the substrate 700 in this embodiment, the invention is not limited to this structure. For example, a structure in which a photolithography method or the like is used and the separation layer 702 is formed over parts of the substrate 700 may be employed.

The insulating film 701 and the insulating film 703 are formed using an insulating material such as silicon oxide, silicon nitride (e.g., SiNₓ or Si₃N₄), silicon oxynitride (SiOₓN_{y}, where x>y>0), silicon nitride oxide (SiNₓO_{y}, where x>y>0), or the like, by a CVD method, a sputtering method, or the like.

The insulating film 701 and the insulating film 703 are provided to prevent an alkali metal, such as Na, or an alkaline earth metal contained in the substrate 700 from diffusing into the semiconductor film 704 and adversely affecting characteristics of a semiconductor element such as a TFT or the like. Further, the insulating film 703 also has roles of preventing an impurity element contained in the separation layer 702 from diffusing into the semiconductor film 704 and of protecting a semiconductor element in a subsequent process step in which the semiconductor element is separated from the substrate 700.

The insulating film 701 and the insulating film 703 may be films which employ a single: insulating film or films in which a plurality of insulating films are stacked. In this embodiment, a silicon oxynitride film with a thickness of 100 nm, a silicon nitride oxide film with a thickness of 50 nm, and a silicon oxynitride film with a thickness of 100 nm are stacked in that order to form the insulating film 703; however, the materials and film thicknesses of each layer and the number of layers stacked are not limited to that. For example, instead of a lower layer which is a silicon oxynitride film, a siloxane-based resin with a thickness of 0.5 to 3 μm may be formed by a spin coat method, a slit coating method, a droplet discharging method, a printing method, or the like. Further, instead of a middle layer which is a silicon nitride oxide film, a silicon nitride (e.g., SiNₓ or Si₃N₄) film may be used. Further, instead of an upper layer which is a silicon oxynitride film, a silicon oxide film may be used. Further, it is desirable that each film thickness is 0.05 to 3 μm, and the film thicknesses can be selected freely within that range.

Alternatively, as the lower layer of the insulating film 703, which is closest to the separation layer 702, a silicon oxynitride film or a silicon oxide film may be formed, the middle layer may be formed from a siloxane-based resin, and a silicon oxide film may be formed as the upper layer.

Note that a siloxane-based resin corresponds to a resin which includes an Si—O—Si bond which is formed using a siloxane-based material as a starting material. As a substituent, a siloxane-based resin may have hydrogen, or at least one of fluorine, an alkyl group, and an aromatic hydrocarbon.

The silicon oxide film can be formed by a method such as thermal CVD, plasma CVD, normal pressure CVD, bias ECRCVD, or the like, using a combination mixed gas such as silane and oxygen, TEOS (tetraethoxysilane) and oxygen, or the like. Further, representatively, the silicon nitride film can be formed by plasma CVD, using a mixed gas which includes silane and ammonia. Furthermore, representatively, the silicon oxynitride film and the silicon nitride oxide film can be formed by plasma CVD, using a mixed gas which includes silane and dinitrogen monoxide.

As the separation layer 702, a metal film, a metal oxide film, or a film in which a metal film and a metal oxide film are stacked can be used. Each of the metal film and the metal oxide film may be a single layer or a stacked layer in which a plurality of layers are stacked. Alternatively, a metal nitride or a metal oxynitride may be used instead of a metal film or a metal oxide film. The separation layer 702 can be formed using a sputtering method; various CVD methods, such as a plasma CVD method; or the like.

As a metal used for the separation layer 702, tungsten (W), molybdenum (Mo), titanium (Ti), tantalum (Ta), niobium (Nb), nickel (Ni), cobalt (Co), zirconium (Zr), zinc (Zn), ruthenium (Ru), rhodium (Rh), palladium (Pd), osmium (Os), iridium (Ir), or the like can be used. A film formed from an alloy containing any of the above-mentioned metals as its main component or a film formed of a compound containing any of the above-mentioned metals may also be used for the separation layer 702, instead of a film formed of any of the above-mentioned metals.

Alternatively, for the separation layer 702, a film formed of silicon (Si) itself or a film formed of a compound containing silicon (Si) as a main component may be used. Further alternatively, a film formed of an alloy containing silicon (Si) and any of the above-mentioned metals may be used. A film containing silicon may be any of amorphous, microcrystalline, and polycrystalline.

As the separation layer 702, an above-mentioned film may be used as a single layer or a plurality of any of the above-mentioned films may be stacked. The separation layer 702 in which a metal film and a metal oxide film are stacked can be obtained by forming a starting metal film and then oxidizing or nitriding a surface thereof. Specifically, a starting metal film may be subjected to plasma treatment in an oxygen atmosphere or a dinitrogen monoxide atmosphere or may be subjected to heat treatment in an oxygen atmosphere or a dinitrogen monoxide atmosphere. Alternatively, oxidation of a starting metal film can be performed by forming a silicon oxide film or a silicon oxynitride film such that it is in contact with an upper surface of the starting metal film. Further, nitridation of a starting metal film can be performed by forming a silicon oxynitride film or a silicon nitride film such that it is in contact with an upper surface of the starting metal film.

As plasma treatment for oxidizing or nitriding a metal film, high-density plasma treatment which employs a high frequency wave such as a microwave (e.g., a wave with a frequency of 2.45 GHz) in which a plasma density is 1×10¹¹ cm⁻³ or more, preferably, 1×10¹¹ to 9×10¹⁵ cm⁻³, may be performed.

Note that the separation layer 702 in which a metal film and a metal oxide film are stacked may be formed by oxidizing a surface of a starting metal film; however, alternatively, a metal oxide film may be separately formed after a metal film has been formed. In a case of using tungsten as a metal, for example, a tungsten film is formed as a starting metal film by a sputtering method, a CVD method, or the like, and then the tungsten film is subjected to plasma treatment. Accordingly, the tungsten film, which corresponds to a metal film, and a metal oxide film formed of an oxide of tungsten, which is in contact with the metal film, can be formed.

Note that an oxide of tungsten is expressed by WOₓ, where x is in the range of greater than or equal to 2 and less than or equal to 3. There are cases where x=2(WO₂), x=2.5(W₂O₅), x=2.75(W₄O₁₁), and x=3(WO₃). In the case of forming an oxide of tungsten, there is no particular limitation on the value of x, and it may be determined based on an etching rate or the like.

It is desirable that, after forming the insulating film 703, the semiconductor film 704 be formed without being exposed to the air. The thickness of the semiconductor film 704 is 20 to 200 nm (desirably, 40 to 170 nm, preferably, 50 to 150 nm). Note that the semiconductor film 704 may be an amorphous semiconductor or a polycrystalline semiconductor. Not only silicon but also silicon germanium can be used for the semiconductor. In the case of using silicon germanium, preferably a concentration of germanium is approximately 0.01 to 4.5 atomic %.

Note that the semiconductor film 704 may be crystallized by a known technique. As a known crystallization method, a laser crystallization method which uses laser light or a crystallization method which uses a catalytic element may be used. Alternatively, a crystallization method which uses a catalytic element and a laser crystallization method can be used in combination. In the case of using a substrate with superior heat resistance, such as a quartz substrate, as the substrate 700, a crystallization method in which at least two or more of a thermal crystallization method which uses an electrically-heated furnace, a lamp annealing crystallization method which uses infrared light, a crystallization method which uses a catalytic element, and a crystallization method which uses high-temperature annealing performed at a temperature of approximately 950° C. are combined may be used.

For example, in the case of using laser crystallization, before laser crystallization is performed, the semiconductor film 704 is subjected to heat treatment at 550° C. for four hours in order to improve resistance of the semiconductor film 704 with respect to the laser. By using a solid state laser which is capable of continuous oscillation and irradiating the semiconductor film 704 with laser light of a second to fourth harmonic of a fundamental wave, large grain crystals can be obtained. For example, typically, it is desirable to use a second harmonic (532 nm) or a third harmonic (355 nm) of an Nd:YVO₄ laser (fundamental wave of 1064 nm). Specifically, laser light emitted from a continuous-wave YVO₄ laser is converted into a harmonic by a non-linear optical element, and thereby, laser light with an output of 10 W is obtained. Then, preferably the laser light is shaped by an optical system such that it has a rectangular or elliptical shape on an irradiation surface, and the semiconductor film 704 is irradiated with the laser light. It is necessary that the power density at this time be approximately 0.01 to 100 MW/cm² (preferably, 0.1 to 10 MW/cm²). Further, the scanning rate is set at approximately 10 to 2000 cm/sec for the irradiation.

As a continuous-wave gas laser, an Ar laser, a Kr laser, or the like can be used. Further, as a continuous-wave solid-state laser, a YAG laser, a YVO₄ laser, a YLF laser, a YAlO₃ laser, a forsterite (Mg₂SiO₄) laser, a GdVO₄ laser, a Y₂O₃ laser, a glass laser, a ruby laser, an alexandrite laser, a Ti:sapphire laser, or the like can be used.

As a pulsed oscillation laser, an Ar laser, a Kr laser, an excimer laser, a CO₂ laser, a YAG laser, a Y₂O₃ laser, a YVO₄ laser, a YLF laser, a YAlO₃ laser, a glass laser, a ruby laser, an alexandrite laser, a Ti:sapphire laser, a copper vapor laser, or a gold vapor laser can be used, for example.

The laser crystallization may be performed using pulsed oscillation laser light with a repetition rate of greater than or equal to 10 MHz, which is a considerably higher frequency band than a commonly used frequency band of several tens to several hundreds of Hz. It is estimated that the time it takes for the semiconductor film 704 to completely solidify after being irradiated with pulsed oscillation laser light and melted is several tens to several hundreds of nanoseconds. Accordingly, when the above-mentioned frequency band is used, before the semiconductor film 704 solidifies after being melted by laser light of a preceding pulse, the semiconductor film 704 can be irradiated with laser light of a next pulse. Therefore, because a solid-liquid interface can be continuously moved in the semiconductor film 704, the semiconductor film 704 which has crystal grains that have grown without a break in a scanning direction is formed. Specifically, a group of crystal grains which have a width of 10 to 30 μm in the scanning direction and a width of approximately 1 to 5 μm in the direction perpendicular to the scanning direction can be formed. By forming single-crystal grains which have grown without a break in the scanning direction, the semiconductor film 704 which has almost no grain boundaries at least in a channel direction of a TFT can be formed.

Note that the laser crystallization may be performed by irradiating using a fundamental wave of a continuous wave laser and a harmonic of a continuous wave laser in parallel, or by irradiating using a fundamental wave of a continuous wave laser and a harmonic of a pulsed laser in parallel.

Note that laser light irradiation may be performed in an inert gas atmosphere of a noble gas, nitrogen, or the like. By performing laser light irradiation in an inert gas atmosphere, roughness of a semiconductor surface caused by the laser light irradiation can be suppressed, and variation of a threshold voltage caused by variation of an interface state density can be suppressed.

By irradiating with the laser light as described above, the semiconductor film 704 with higher crystallinity is formed. Note that a polycrystalline semiconductor formed in advance by a sputtering method, a plasma CVD method, a thermal CVD method, or the like may be used as the semiconductor film 704.

The semiconductor film 704 is crystallized in this embodiment; however, an amorphous semiconductor film or a microcrystalline semiconductor film may be subjected to a process described below directly, without being crystallized. TFTs which use an amorphous semiconductor or a microcrystalline semiconductor have advantages of lower cost and higher yield, because they require fewer manufacturing processes than TFTs which use a polycrystalline semiconductor.

An amorphous semiconductor can be obtained by glow discharge decomposition of a gas containing silicon. As a gas containing silicon, SiH₄ and Si₂H₆ can be used. The gas containing silicon may be diluted with hydrogen or hydrogen and helium.

Next, the semiconductor film 704 is subjected to channel doping, in which an impurity element which imparts p-type conductivity or an impurity element which imparts n-type conductivity is added at a low concentration. The entire semiconductor film 704 may be subjected to channel doping, or a selected part of the semiconductor film 704 may be subjected to channel doping. As an impurity element which imparts p-type conductivity, boron (B), aluminum (Al), gallium (Ga), or the like can be used. As an impurity element which imparts n-type conductivity, phosphorus (P), arsenic (As), or the like can be used. Here, boron (B) is used as the impurity element, and is added such that it is contained in a channel-doped part of the semiconductor film 704 at a concentration of 1×10¹⁶ to 5×10¹⁷ cm³.

Next, as shown in FIG. 13B, the semiconductor film 704 is processed (patterned) into a predetermined shape, so that island-shaped semiconductor films 705 to 708 are formed. Then, a gate insulating film 709 is formed such that it covers the island-shaped semiconductor films 705 to 708. The gate insulating film 709 can be formed as a single layer or stacked layer of a film containing silicon nitride, silicon oxide, silicon nitride oxide, or silicon oxynitride, using a plasma CVD method, a sputtering method, or the like. In the case of a stacked layer, a three-layer structure, for example, a structure in which a silicon oxide film, a silicon nitride film, and another silicon oxide film are stacked in that order from the substrate 700 side, is preferably employed.

The gate insulating film 709 may be formed by oxidizing or nitriding surfaces of the island-shaped semiconductor films 705 to 708 using a high-density plasma treatment. The high-density plasma treatment is performed using a mixed gas, which contains a noble gas, such as He, Ar, Kr, or Xe, and oxygen, nitrogen oxide, ammonia, nitrogen, hydrogen, or the like, for example. In this case, when excitation of a plasma is performed by introducing a microwave, a plasma with a low electron temperature and a high density can be generated. By oxidizing or nitriding the surfaces of the semiconductor films using oxygen radicals (OH radicals may be included) or nitrogen radicals (NH radicals may be included) generated by such a high density plasma, an insulating film with a thickness of 1 to 20 nm, typically, 5 to 10 nm, is formed such that it is in contact with the semiconductor films. The insulating film with a thickness of 5 to 10 nm is used as the gate insulating film 709.

Oxidation or nitridation of the semiconductor films by the above-described high-density plasma treatment proceeds by a solid-phase reaction; therefore, interface state density between the gate insulating film and the semiconductor films can be greatly reduced. Further, since the semiconductor films are directly oxidized or nitrided by the high-density plasma treatment, variation in thickness of the insulating film which is formed can be suppressed. In the case where the semiconductor films have crystallinity, when the high-density plasma treatment is used to oxidize surfaces of the semiconductor films by a solid-phase reaction, it is possible to suppress rapid oxidation in just grain boundaries; thus, a gate insulating film with good uniformity and low interface state density can be formed. When the insulating film formed by the high-density plasma treatment is included in part or all of a gate insulating film of transistors, variations in characteristics of the transistors can be suppressed.

Next, as shown in FIG. 13C, a conductive film is formed over the gate insulating film 709 and then the conductive film is processed (patterned) into a predetermined shape, so that electrodes 710 are formed above the island-shaped semiconductor films 705 to 708. In this embodiment, two stacked conductive films are patterned to form the electrodes 710. The conductive films can be formed from tantalum (Ta), tungsten (W), titanium (Ti), molybdenum (Mo), aluminum (Al), copper (Cu), chromium (Cr), niobium (Nb), or the like; an alloy containing any of the above metals as its main component; or a compound containing any of the above metals. Alternatively, the conductive films may be formed from a semiconductor, such as polycrystalline silicon in which a semiconductor film is doped with an impurity element such as phosphorus which imparts conductivity.

In this embodiment, a tantalum nitride film or a tantalum (Ta) film is used as a first conductive film, and a tungsten (W) film is used as a second conductive film. As a combination of two conductive films, besides the example described in this embodiment, a tungsten nitride film and a tungsten film; a molybdenum nitride film and a molybdenum film; an aluminum film and a tantalum film; an aluminum film and a titanium film, and the like can be used. Since tungsten and tantalum nitride have high heat resistance, heat treatment for the purpose of thermal activation can be performed in a process step subsequent to the formation of the two conductive films. Further, as a combination of two conductive films, nickel silicide and silicon doped with an impurity which imparts n-type conductivity; WSiₓ and silicon doped with an impurity which imparts n-type conductivity; or the like can be used, for example.

In this embodiment, the electrodes 710 are formed using two stacked conductive films; however, this embodiment is not limited to this structure. The electrodes 710 may be formed using a single conductive film or three or more stacked conductive films. In the case of a three-layer structure in which three or more conductive films are stacked, a stacked-layer structure which includes a molybdenum film, an aluminum film, and another molybdenum film may be employed.

The conductive films can be formed by a CVD method, a sputtering method, or the like. In this embodiment, the first conductive film is formed to a thickness of 20 to 100 nm, and the second conductive film is formed to a thickness of 100 to 400 nm.

Note that as a mask used when the electrodes 710 are formed, a mask of silicon oxide, silicon oxynitride, or the like may be used instead of a resist. In that case, a process step of patterning the mask of silicon oxide, silicon oxynitride, or the like is added to the process; however, because less of the mask film is removed in an etching compared to how much of a resist is removed in an etching, the electrodes 710 can be formed with a desired width. Alternatively, the electrodes 710 may be selectively formed using a droplet discharging method, without using a mask.

Note that a droplet discharging method refers to a method in which droplets containing a predetermined composition are discharged or ejected from fine pores to form a predetermined pattern, and may be an ink-jet method or the like.

Next, the island-shaped semiconductor films 705 to 708 are doped at a low concentration with an impurity element which imparts n-type conductivity (typically, phosphorus (P) or arsenic (As)), using the electrodes 710 as a mask (a first doping step). Conditions for the first doping step are a dose of 1×10¹⁵ to 1×10¹⁹/cm³ and an accelerating voltage of 50 to 70 keV; however, the conditions are not limited thereto. In the first doping step, the island-shaped semiconductor films 705 to 708 are doped via the gate insulating film 709 to form low-concentration impurity regions 711 in each of the island-shaped semiconductor films 705 to 708. Note that the island-shaped semiconductor film 706 which is to form a p-channel TFT may be covered with the mask in the first doping step.

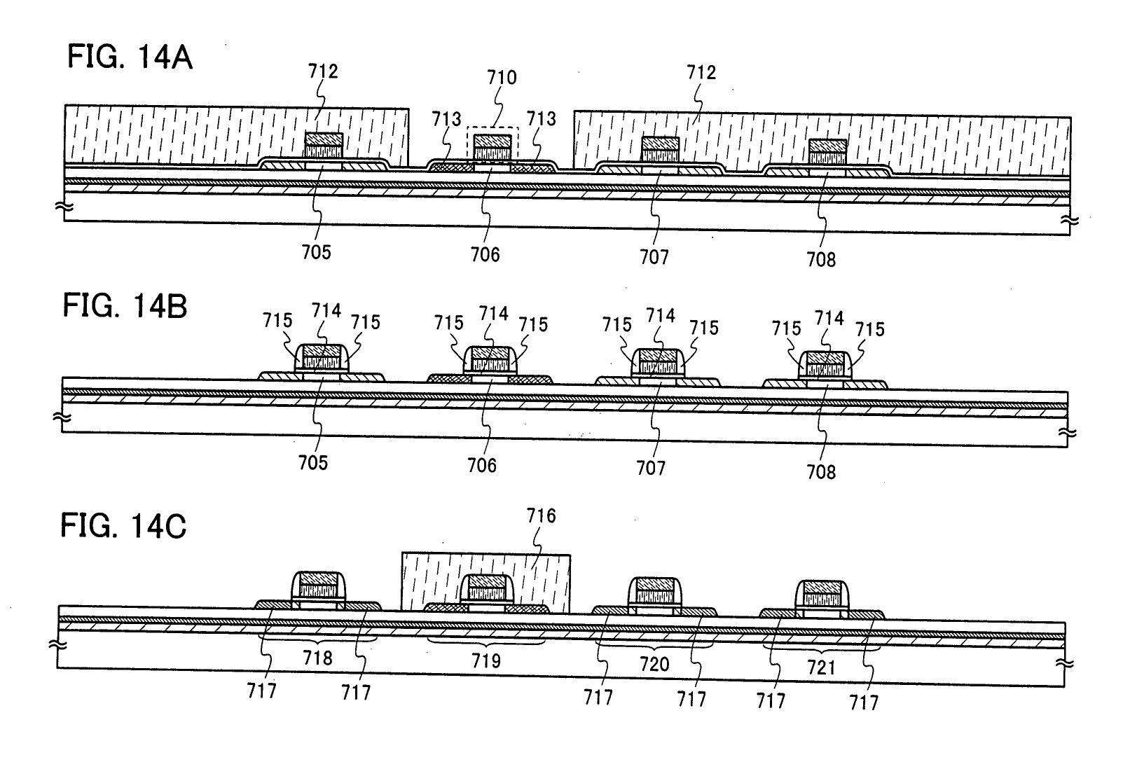

Next, as shown in FIG. 14A, a mask 712 is formed such that it covers the island-shaped semiconductor films 705, 707, and 708, which are to form n-channel TFTs. The island-shaped semiconductor film 706 is doped at a high concentration with an impurity element which imparts p-type conductivity (typically, boron (B)), using the electrodes 710 and the mask 712 as masks (a second doping step). Conditions for the second doping step are a dose of 1×10¹⁹ to 1×10²⁰/cm³ and an accelerating voltage of 20 to 40 keV. In the second doping step, the island-shaped semiconductor film 706 is doped via the gate insulating film 709 to form p-type high-concentration impurity regions 713 in the island-shaped semiconductor film 706.

Next, after the mask 712 is removed by ashing or the like, as shown in FIG. 14B, an insulating film is formed such that it covers the gate insulating film 709 and the electrodes 710. The insulating film is formed by a plasma CVD method, a sputtering method, or the like, as a single layer or stacked layer which includes a silicon film, a silicon oxide film, a silicon oxynitride film, a silicon nitride oxide film, or a film containing an organic material, such as an organic resin. In this embodiment, a silicon oxide film with a thickness of 100 nm is formed by a plasma CVD method.

Next, the gate insulating film 709 and the insulating film are partially etched using anisotropic etching, which mainly etches in a vertical direction. The gate insulating film 709 is partially etched by the anisotropic etching to form a gate insulating film 714 which is formed sectionally over the island-shaped semiconductor films 705 to 708. Further, by the anisotropic etching, the insulating film which was formed so as to cover the gate insulating film 709 and the electrodes 710 is partially etched to form sidewalls 715 which are in contact with side surfaces of the electrodes 710. The sidewalls 715 are used as a mask for doping when an LDD (lightly-doped drain) region is formed. In this embodiment, a mixed gas which includes CHF₃ and He is used as an etching gas. Note that the process for forming the sidewalls 715 is not limited to this.

Next, as shown in FIG. 14C, a mask 716 is formed such that it covers the island-shaped semiconductor film 706 which is to form a p-channel TFT. Then, the island-shaped semiconductor films 705, 707, and 708 are doped at a high concentration with an impurity element which imparts n-type conductivity (typically, P or As), using the electrodes 710 and the sidewalls 715 as well as the formed mask 716 as masks (a third doping step). Conditions for the third doping step are a dose of 1×10¹⁹ to 1×10²⁰/cm³ and an accelerating voltage of 60 to 100 keV. Through the third doping step, n-type high-concentration impurity regions 717 are formed in the island-shaped semiconductor films 705, 707, and 708.

Note that the sidewalls 715 serve as a mask in a subsequent step, in which doping is performed using an impurity which imparts n-type conductivity at a high concentration, and low-concentration impurity regions or non-doped offset regions are formed under the sidewalls 715. Therefore, in order to control a width of the low-concentration impurity regions or the offset regions, conditions of the anisotropic etching at the time of forming the sidewalls 715 or a thickness of the insulating film for forming the sidewalls 715 may be changed as appropriate so that the size of the sidewalls 715 is adjusted. Note that low-concentration impurity regions or non-doped offset regions may be formed in the semiconductor film 706 under the sidewalls 715.

Next, after the mask 716 is removed by ashing or the like, the impurity regions may be activated by heat treatment. For example, after a silicon oxynitride film is formed to a thickness of 50 nm, heat treatment may be performed at 550° C. for 4 hours in a nitrogen atmosphere.

Alternatively, after forming a silicon nitride film containing hydrogen to a thickness of 100 nm, heat treatment may be performed in a nitrogen atmosphere at 410° C. for one hour to hydrogenate the island-shaped semiconductor films 705 to 708. Further alternatively, heat treatment may be performed in an atmosphere containing hydrogen at a temperature of 300 to 450° C. for one to twelve hours to hydrogenate the island-shaped semiconductor films 705 to 708. For the heat treatment, thermal annealing, a laser annealing method, an RTA method, or the like can be employed. Through the heat treatment, not just hydrogenation, but also activation of the impurity element added to the semiconductor films can be performed. As an alternative method of hydrogenation, plasma hydrogenation (which employs hydrogen excited by plasma) may be performed. In the hydrogenation process, dangling bonds can be terminated by the thermally excited hydrogen.

Through the above series of steps, n-channel TFTs 718 and 721, a capacitor 720, and the p-channel TFT 719 are formed. Note that the capacitor 720 includes the island-shaped semiconductor film 707, which serves as an electrode; the gate insulating film 714, and the electrode 710.

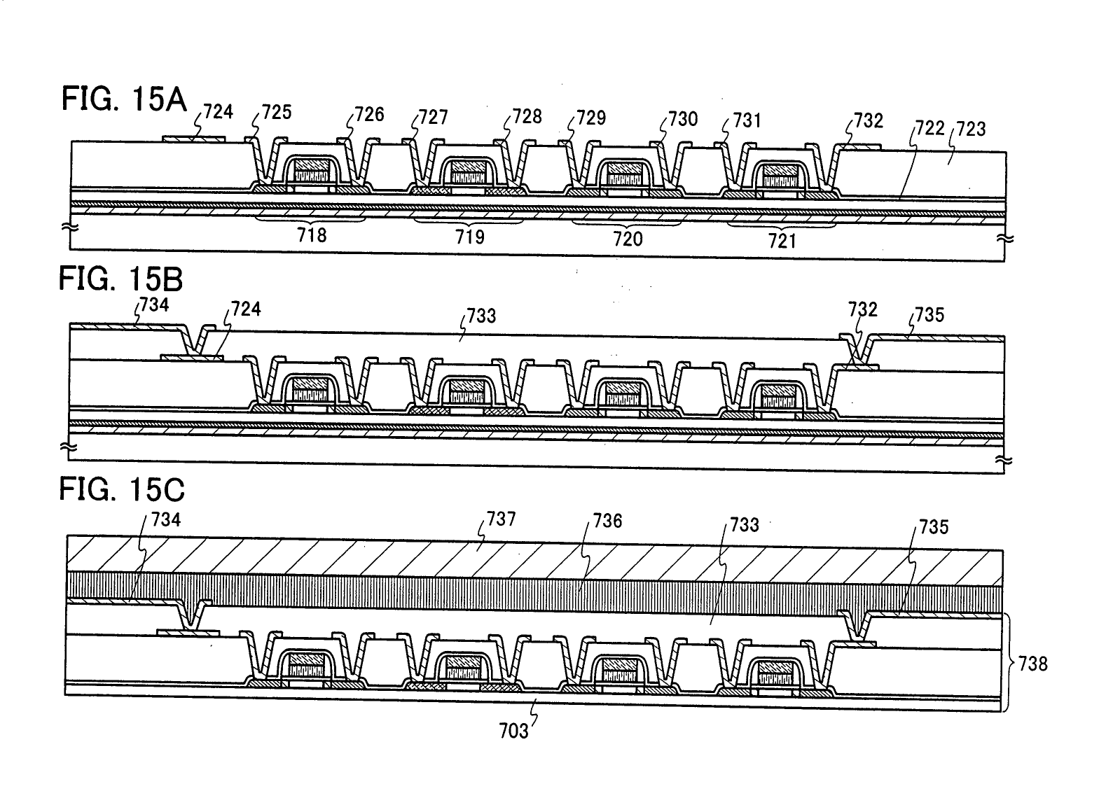

Next, as shown in FIG. 15A, an insulting film 722 which protects the TFTs 718, 719, and 721 and the capacitor 720 is formed. The insulating film 722 is not necessarily provided; however, by forming the insulating film 722, impurities such as alkali metals or alkaline earth metals can be prevented from penetrating the TFTs 718, 719, and 721 and the capacitor 720. Specifically, it is desirable that silicon nitride, silicon nitride oxide, aluminum nitride, aluminum oxide, silicon oxide, or the like is used as the insulating film 722. In this embodiment, a silicon oxynitride film with a thickness of approximately 600 nm is used as the insulating film 722. In this case, the above-mentioned hydrogenation process may be performed after the silicon oxynitride film is formed.

Next, an insulating film 723 is formed over the insulating film 722 such that it covers the TFTs 718, 719, and 721 and the capacitor 720. For the insulating film 723, a heat-resistant organic material such as an acrylic, a polyimide, benzocyclobutene, a polyamide, or an epoxy can be used. Further, besides the above-mentioned organic materials, low-dielectric constant materials (low-k materials), a siloxane-based resin, silicon oxide, silicon nitride, silicon oxynitride, silicon nitride oxide, PSG (phosphosilicate glass), BPSG (borophosphosilicate glass), alumina, and the like can be used. Besides hydrogen, a siloxane-based resin may include at least one of fluorine, an alkyl group, and an aromatic hydrocarbon as a substituent. Note that the insulating film 723 may be formed by stacking a plurality of insulating films formed of any of the above-mentioned materials.

The insulating film 723 can be formed by a CVD method, a sputtering method, an SOG method, spin coating, dipping, spray coating, a droplet discharging method (an ink-jet method, screen printing, offset printing, or the like), a doctor knife, a roll coater, a curtain coater, a knife coater, or the like, depending on a material of the insulating film 723.

Next, contact holes are formed in the insulating film 722 and the insulating film 723 such that each of the island-shaped semiconductor films 705 to 708 is partially exposed. Then, a conductive film 724 and conductive films 725 to 732, which are in contact with the island-shaped semiconductor films 705 to 708 via the contact holes, are formed. As an etching gas for forming the contact holes, a mixed gas which includes CHF₃ and He is employed; however, the etching gas is not limited thereto.

The conductive films 724 to 732 can be formed by a CVD method, a sputtering method, or the like. Specifically, for the conductive films 724 to 732, aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), carbon (C), silicon (Si), or the like can be used. Further, an alloy containing any of the above-mentioned metals as its main component or a compound containing any of the above-mentioned metals may be used. Each of the conductive films 724 to 732 can be formed as a single layer of a film which employs any of the above-mentioned metals or as a stacked layer which includes a plurality of such films.

Examples of an alloy which contains aluminum as its main component are an alloy containing aluminum as its main component and also containing nickel, and an alloy containing aluminum as its main component and also containing nickel and one or both of carbon and silicon. Aluminum and aluminum silicon are ideal materials for forming the conductive films 724 to 732 because they have low resistance and are inexpensive. In particular, when an aluminum silicon film is employed, formation of hillocks during resist baking in patterning of the conductive films 724 to 732 can be prevented, compared to when an aluminum film is employed. Further, instead of silicon (Si), the aluminum film may include approximately 0.5% Cu.

For the conductive films 724 to 732, for example, a stacked-layer structure which includes a barrier film, an aluminum silicon film, and another barrier film; or a stacked-layer structure which includes a barrier film, an aluminum silicon film, a titanium nitride film, and another barrier film is preferably employed. Note that a barrier film refers to a film formed using titanium, a nitride of titanium, molybdenum, or a nitride of molybdenum. When barrier films are formed such that they sandwich an aluminum silicon film, formation of a hillock of aluminum or aluminum silicon can be further prevented. Further, when a barrier film is formed using titanium, which is a highly reducible element, even if a thin oxide film forms over the island-shaped semiconductor films 705 to 708, the oxide film is reduced by titanium contained in the barrier film so that good contact between the conductive films 725 to 732 and the island-shaped semiconductor films 705 to 708 can be obtained. Alternatively, a plurality of barrier films may be stacked. In that case, for example, each of the conductive films 724 to 732 can be formed as a five-layer structure in which titanium, titanium nitride, aluminum silicon, titanium, and titanium nitride are stacked in that order from a lower layer side.

Note that the conductive films 725 and 726 are connected to the high-concentration impurity regions 717 of the n-channel TFT 718. The conductive films 727 and 728 are connected to the high-concentration impurity regions 713 of the p-channel TFT 719. The conductive films 731 and 732 are connected to the high-concentration impurity regions 717 of the n-channel TFT 721. The conductive films 729 and 730 are connected to the high-concentration impurity regions 717 of the capacitor 720.

Next, as shown in FIG. 15B, an insulating film 733 is formed such that it covers the conductive films 724 to 732, and after that, contact holes are formed in the insulating film 733 such that parts of the conductive films 724 and 732 are exposed. Then, conductive films 734 and 735 are formed in the contact holes, such that they are in contact with the conductive films 724 and 732, respectively. Any material which can be used for the conductive films 724 to 732 can be used as a material for the conductive films 734 and 735.

The insulating film 733 can be formed using an organic resin film, an inorganic insulating film, or a siloxane-based insulating film. For an organic resin film, an acrylic, an epoxy, a polyimide, a polyamide, polyvinylphenol, benzocyclobutene, or the like can be used, for example. As an inorganic insulating film, a film which contains silicon oxide, silicon oxynitride, silicon nitride oxide, or carbon, typified by diamond-like carbon (DLC), or the like can be used. Note that a mask used for forming an opening by a photolithography method can be formed by a droplet discharging method or a printing method. Further, the insulating film 733 can be formed by a CVD method, a sputtering method, a droplet discharging method, a printing method, or the like, depending on a material of the insulating film 733.

Next, as shown in FIG. 15C, a protective layer 736 is formed over the insulating film 733 such that it covers the conductive films 734 and 735. For the protective layer 736, a material is used which can protect the insulating film 733 and the conductive films 734 and 735 when the substrate 700 is removed using the separation layer 702 as a boundary in a subsequent process step. For example, the protective layer 736 can be formed by applying an epoxy-based resin, an acrylate-based resin, or a silicon-based resin, which is soluble in water or in alcohols, over an entire surface.

In this embodiment, the protective layer 736 is formed in the following manner: a water-soluble resin (manufactured by Toagosei Co., Ltd.: VL-WSHL10) is applied to a thickness of 30 μm by a spin coating method and exposed for 2 minutes so that it is temporarily hardened. Then, the resin is exposed to UV light for a total of 12.5 minutes, including 2.5 minutes of exposure of a back surface and 10 minutes of exposure of a front surface, to fully harden the resin and thus form the protective layer 736. Further, in the case of stacking a plurality of organic resins, depending on a solvent used, the stacked organic resins might be partly melted during application or baking, or adhesiveness might become too high. Therefore, in the case of forming both the insulating film 733 and the protective layer 736 using an organic resin that is soluble in the same solvent, it is preferable to form an inorganic insulating film (e.g., a silicon nitride film, a silicon nitride oxide film, an AlNₓ film, or an AlNₓO_{y} film) such that it covers the insulating film 733, so that removal of the protective layer 736 proceeds smoothly in a subsequent step.

Next, as shown in FIG. 15C, a layer (hereinafter referred to as an element forming layer 738) which includes a semiconductor element, typified by a TFT, and various conductive films, which includes from the insulating film 703 through to the conductive films 734 and 735 formed over the insulating film 733, and the protective layer 736 are separated from the substrate 700. In this embodiment, a first sheet material 737 is attached to the protective layer 736, and physical force is used to separate the element forming layer 738 and the protective layer 736 from the substrate 700. A part of the separation layer 702 may be left, rather than all of the separation layer 702 being removed.

Alternatively, the separation may be performed using a method which employs etching of the separation layer 702. In that case, a groove is formed such that part of the separation layer 702 is exposed. The groove is formed by dicing, scribing, a process which employs laser light that contains UV light, a photolithography method, or the like. The groove has a depth sufficient such that the separation layer 702 is exposed. A halogen fluoride is used as an etching gas, and the gas is introduced through the groove. In this embodiment, conditions for performing the etching are, for example: use of chlorine trifluoride (ClF₃); a temperature of 350° C.; a flow rate of 300 sccm; a pressure of 800 Pa; and a processing time of three hours. Further, a gas in which nitrogen is mixed with a ClF₃ gas may be used. When a halogen fluoride such as ClF₃ is used, the separation layer 702 can be selectively etched and the substrate 700 can be separated from the element forming layer 738. Note that the halogen fluoride may be in either a gas or a liquid state.

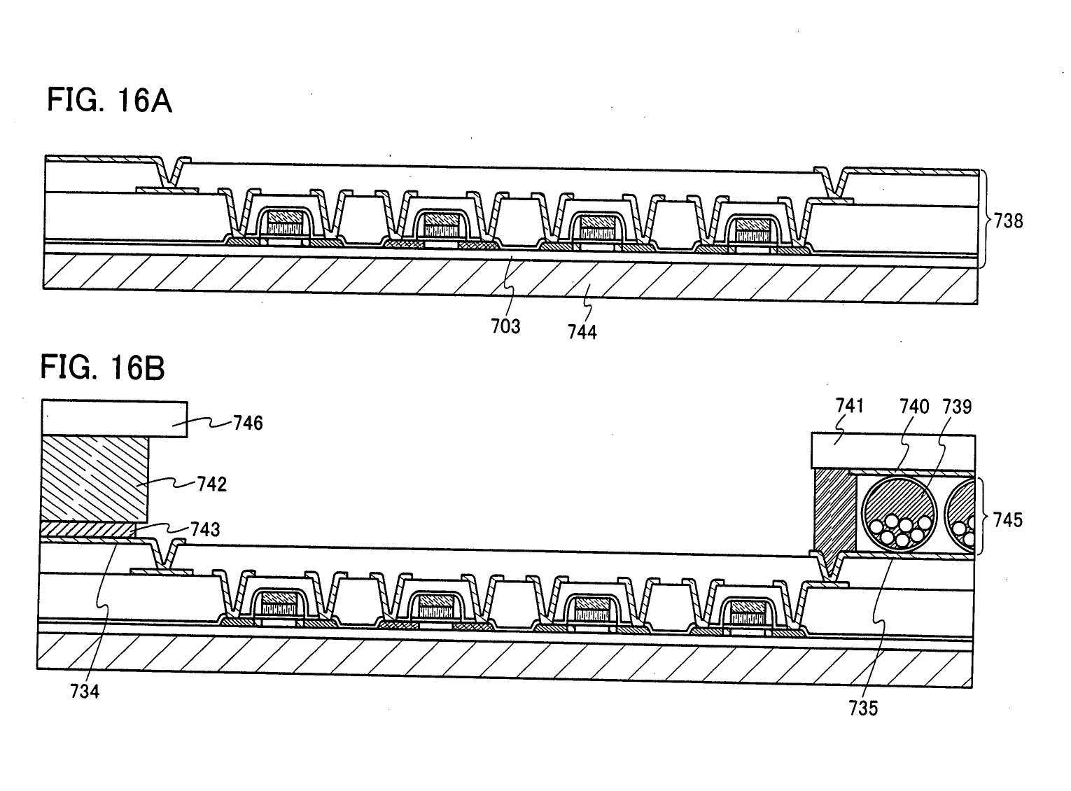

Next, as shown in FIG. 16A, a second sheet material 744 is attached to a surface of the element forming layer 738 which was exposed by the separation. Then, after separating the element forming layer 738 and the protective layer 736 from the first sheet material 737, the protective layer 736 is removed.

As the second sheet material 744, a glass substrate formed from barium borosilicate glass, aluminoborosilicate glass, or the like, or an organic material such as flexible paper, plastic, or the like can be used, for example. Alternatively, a flexible inorganic material may be used as the second sheet material 744. ARTON (manufactured by JSR) formed from polynorbornene having a polar group can be used to form a plastic substrate. Further, a polyester, typified by polyethylene terephthalate (PET); polyether sulfone (PES); polyethylene naphthalate (PEN); polycarbonate (PC); a nylon; polyether etherketone (PEEK); polysulfone (PSF); polyether imide (PEI); polyarylate (PAR); polybutylene terephthalate (PBT); a polyimide; an acrylonitrile butadiene styrene resin; poly vinyl chloride; polypropylene; poly vinyl acetate; an acrylic resin; or the like can be used.

Note that in the case where semiconductor elements which correspond to a plurality of memory carriers are formed over the substrate 700, the element forming layer 738 is divided such that the memory carriers are separated from each other. The division can be performed using a laser irradiation apparatus, a dicing apparatus, a scribing apparatus, or the like.

Next, as shown in FIG. 16B, a display material having a memory property is used to form a pixel portion. In this embodiment, an example is described in which a display material 745 which includes microcapsules 739 is used. The display material 745 can be selectively applied over the conductive film 735 which serves as an electrode, by using a printing method, for example. Then, a substrate 741 provided with a conductive film 740 is attached to the second sheet material 744 such that the display material 745 is sandwiched between the conductive film 735 and the conductive film 740. Any material which can be used to form the conductive film 735 can be used as a material of the conductive film 740.

In this embodiment, a microcapsule of a type in which a plurality of white fine particles which include Ti are dispersed in a blue solution is used as the microcapsule 739. When a voltage is applied to the microcapsule 739, the white fine particles electrophorese through the microcapsule 739, and thus white or blue display can be performed, depending on the polarity of the voltage.

Note that the microcapsule which can be used in the invention is not limited to this type. For example, in the invention, spherical microcapsules which each have one black hemisphere and one white hemisphere which charge differently to each other may also be used. In the case of using this type of microcapsule, a solvent is provided so that the microcapsules are suspended in the display material, such that the microcapsules can freely move round when a voltage is applied.

Next, as shown in FIG. 16B, an antenna 742, with which a support 746 is provided, is electrically connected to the conductive film 734. Electrical connection between the antenna 742 and the conductive film 734 can be performed by pressure bonding the antenna 742 and the conductive film 734 using an anisotropic conductive film (ACF) 743. Pressure bonding may also be performed using an anisotropic conductive paste (ACP) or the like as an alternative to the anisotropic conductive film. Alternatively, the connection can be performed using a conductive adhesive, such as a silver paste, a copper paste, a carbon paste, or the like; soldering; or the like.

Further, in this embodiment, an example in which the separately prepared antenna 742 is electrically connected to the semiconductor element after the semiconductor element has been formed is described; however, the invention is not limited to this structure. The antenna may be formed over the same substrate as the semiconductor element. In that case, a conductive film which serves as the antenna is formed such that a part of the conductive film which serves as the antenna is in contact with the conductive film 734. The conductive film which serves as the antenna can be formed using a metal such as silver (Ag), gold (Au), copper (Cu), palladium (Pd), chromium (Cr), platinum (Pt), molybdenum (Mo), titanium (Ti), tantalum (Ta), tungsten (W), aluminum (Al), iron (Fe), cobalt (Co), zinc (Zn), tin (Sn), nickel (Ni), or the like. Alternatively, a film formed of an alloy containing any of the above metals as its main component or a film formed using a compound containing any of the above metals may be used as the conductive film which serves as the antenna, instead of a film formed of any of the above metals. For the conductive film which serves as the antenna, a single layer of any of the above-mentioned films or a stacked layer which includes two or more of the above-mentioned films may be used.

The conductive film which serves as the antenna can be formed by a CVD method; a sputtering method; a printing method, such as screen printing, gravure printing, or the like; a droplet discharging method; a dispenser method; a plating method; a photolithography method; an evaporation method; or the like.

For example, in the case of using a screen printing method, the conductive film which serves as the antenna can be formed by selectively printing a conductive paste, in which conductive particles having a grain size of from several nanometers to several tens of micrometers are dispersed in an organic resin, over the insulating film 733. The conductive particles can be formed using silver (Ag), gold (Au), copper (Cu), nickel (Ni), platinum (Pt), palladium (Pd), tantalum (Ta), molybdenum (Mo), tin (Sn), lead (Pb), zinc (Zn), chromium (Cr), titanium (Ti), or the like. Alternatively, an alloy containing any of the above-mentioned metals as its main component or a compound containing any of the above-mentioned metals may be used to form the conductive particles, instead of a film formed of any of the above-mentioned metals. Alternatively, fine particles or dispersive nanoparticles of silver halide can be used. As an organic resin contained in the conductive paste, a polyimide, a siloxane-based resin, an epoxy resin, a silicon resin, or the like can be used.

Examples of alloys of the above-mentioned metals are combinations of silver (Ag) and palladium (Pd), silver (Ag) and platinum (Pt), gold (Au) and platinum (Pt), gold (Au) and palladium (Pd), and silver (Ag) and copper (Cu). Alternatively, conductive particles in which copper (Cu) is coated with silver (Ag), or the like can be used, for example.

Note that when forming the conductive film which serves as the antenna, preferably baking is performed after the conductive paste is applied by a printing method or a droplet discharging method. For example, in the case where conductive particles (with a grain size of greater than or equal to one nm and less than or equal to 100 nm, for example) containing silver as their main component are used for the conductive paste, the conductive film which serves as the antenna can be formed by baking the conductive paste at a temperature in the range of 150 to 300° C. Baking may be performed by lamp annealing which uses an infrared lamp, a xenon lamp, a halogen lamp, or the like; furnace annealing which uses an electric furnace; or a laser annealing method which uses an excimer laser or an Nd:YAG laser. Alternatively, fine particles containing solder or lead-free solder as their main component may be used. In that case, it is preferable to use fine particles having a grain size of 20 μm or less. Solder and lead-free solder have advantages such as low cost.

When a printing method or a droplet discharging method is used, the conductive film which serves as the antenna can be formed without using an exposure mask. Further, when a printing method or a droplet discharging method is used, waste of material which would be removed by etching can be avoided, as opposed to the case of using a photolithography method. Further, since it is not necessary to use an expensive exposure mask, the cost of manufacturing a memory carrier can be reduced.

Further, an example in which the element forming layer 738 is used after being separated from the substrate 700 is described in this embodiment; however, alternatively, the element formation layer 738 may be manufactured over the substrate 700 and used as a memory carrier without providing the separation layer 702.

Further, in this embodiment, the thicknesses of the gate insulating films 714 are the same in all the TFTs, that is, the TFTs 718, 719, and 721, and in the capacitor 720; however, the invention is not limited to this structure. For example, the thickness of the gate insulating film 714 included in the capacitor 720 may be different to the thicknesses of the gate insulating films 714 included in the TFTs 718, 719, and 721. Alternatively, in a circuit in which higher speed driving is necessary, the thicknesses of gate insulating films included in TFTs may be smaller than the thicknesses of gate insulating films of TFTs in other circuits.

Further, although description is made with reference to an example of a thin film transistor in this embodiment, the invention is not limited to this structure. Besides a thin film transistor, a transistor formed using single-crystal silicon, a transistor formed using a SOI structure, or the like can be used. Further, a transistor which employs an organic semiconductor or a transistor which employs a carbon nanotube may be used.

This embodiment can be combined as appropriate with the above-described embodiment modes or embodiments.

### Embodiment 6

In this embodiment, a manufacturing method of the invention in which an insulating film is formed over a semiconductor element formed using a single-crystal substrate is described. Note that in this embodiment, description is made with reference to an example where a transistor is used as a semiconductor element; however, the semiconductor element formed using the single-crystal substrate is not limited to being a transistor.

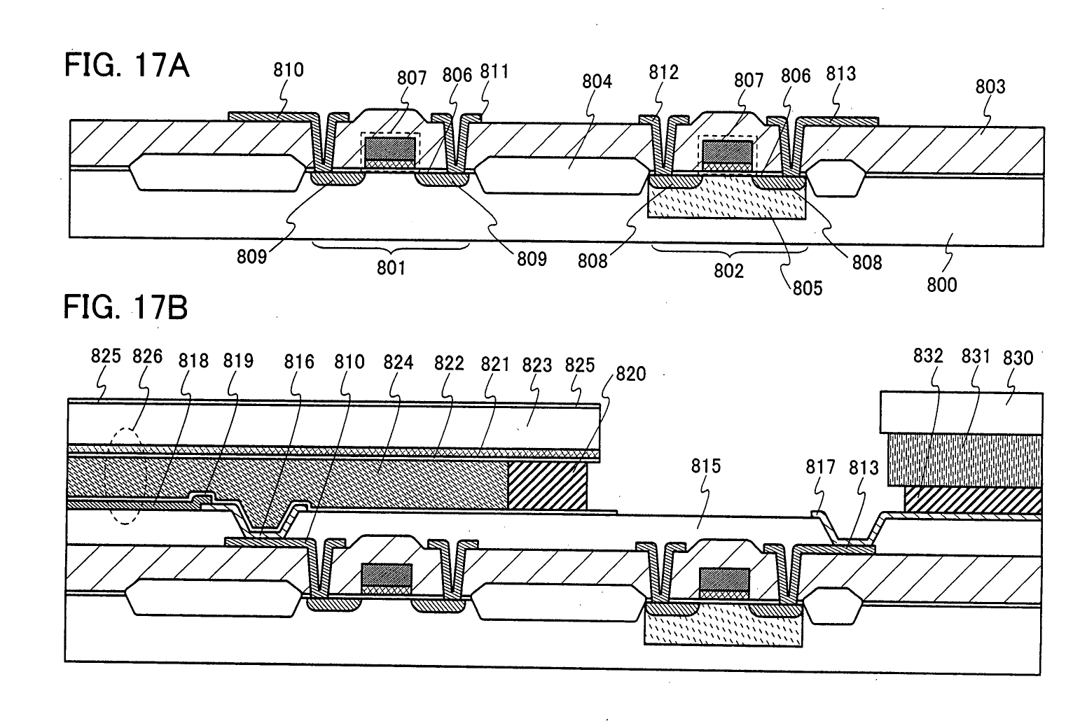

First, as shown in FIG. 17A, an insulating film 803 is formed such that it covers transistors 801 and 802 formed using a semiconductor substrate 800.

As the semiconductor substrate 800, a single-crystal silicon substrate having n-type or p-type conductivity, a compound semiconductor substrate (e.g., a GaAs substrate, an InP substrate, a GaN substrate, a SiC substrate, a sapphire substrate, or a ZnSe substrate), a SOI (silicon-on-insulator) substrate formed using a bonding method or a SIMOX (separation by implantation of oxygen) method, or the like can be used, for example.

The transistor 801 and the transistor 802 are electrically isolated from each other by an insulating film 804 for element isolation. The insulating film 804 for element isolation can be formed by a selective oxidation method (LOCOS: local oxidation of silicon) method, a trench isolation method, or the like.

Further, a p-well 805 is formed in the semiconductor substrate 800, and the transistor 802 is formed in the p-well 805. Note that in this embodiment, an example is described in which a single-crystal silicon substrate having n-type conductivity is used as the semiconductor substrate 800, and the p-well 805 is formed in the semiconductor substrate 800. The p-well 805 formed in the semiconductor substrate 800 can be formed by selectively introducing an impurity element which imparts p-type conductivity to the semiconductor substrate 800. As an impurity element which imparts p-type conductivity, boron (B), aluminum (Al), gallium (Ga), or the like can be used.

Note that in this embodiment, because a semiconductor substrate having n-type conductivity is used as the semiconductor substrate 800, an n-well is not formed in a region where the transistor 801 is formed. However, an n-well may be formed in the region where the transistor 801 is formed by introducing an impurity element which imparts n-type conductivity. As an impurity element which imparts n-type conductivity, phosphorus (P), arsenic (As), or the like can be used.

Further, in the case where a semiconductor substrate having p-type conductivity is used as the semiconductor substrate 800, an impurity element which imparts n-type conductivity may be selectively introduced to the semiconductor substrate to form an n-well. Then, the transistor 801 can be formed in the n-well.

The transistor 801 and the transistor 802 each include a gate insulating film 806. In this embodiment, a silicon oxide film formed by thermally oxidizing the semiconductor substrate 800 is used for the gate insulating films 806. Alternatively, after forming a silicon oxide film using thermal oxidation, a surface of the silicon oxide film may be nitrided by a nitriding treatment to form a silicon oxynitride film, and a layer in which the silicon oxide film and the silicon oxynitride film are stacked may be used as the gate insulating films 806. Alternatively, the gate insulating films 806 may be formed using plasma treatment rather than thermal oxidation. For example, by oxidizing or nitriding a surface of the semiconductor substrate 800 using a high-density plasma treatment, a silicon oxide (SiOₓ) film or a silicon nitride (SiNₓ) film which is used as the gate insulating films 806 can be formed.

Further, the transistor 801 and the transistor 802 each include a conductive film 807 which is over the gate insulating film 806. This embodiment describes an example in which the conductive films 807 are formed using a conductive film formed by stacking two layers in turn. A single-layer conductive film or a structure in which three or more conductive films are stacked may also be used for the conductive films 807.

For the conductive films 807, tantalum (Ta), tungsten (W), titanium (Ti), molybdenum (Mo), aluminum (Al), copper (Cu), chromium (Cr), niobium (Nb), or the like can be used. Alternatively, a film formed using an alloy containing any of the above-mentioned metals as its main component or a film formed using a compound containing any of the above-mentioned metals may be used for the conductive films 807, instead of a film formed using any of the above-mentioned metals. Further alternatively, the conductive films 807 may be formed using a semiconductor, such as polycrystalline silicon in which a semiconductor film is doped with an impurity element such as phosphorus which imparts conductivity. In this embodiment, the conductive films 807 have a structure in which a conductive film using tantalum nitride and a conductive film using tungsten are stacked.

Further, the transistor 801 includes a pair of impurity regions 809 which each serve as a source region or a drain region and are in the semiconductor substrate 800. A region between the pair of impurity regions 809 corresponds to a channel forming region of the transistor 801. As an impurity element, an impurity element which imparts n-type conductivity or an impurity element which imparts p-type conductivity is used. Phosphorus (P), arsenic (As), or the like can be used as an impurity element which imparts n-type conductivity. Boron (B), aluminum (Al), gallium (Ga), or the like can be used as an impurity element which imparts p-type conductivity. In this embodiment, boron (B) is used as an impurity element.

Further, the transistor 802 includes a pair of impurity regions 808 which each serve as a source region or a drain region and are in the p-well 805 of the semiconductor substrate 800. A region between the pair of impurity regions 808 corresponds to a channel forming region of the transistor 802. As an impurity element, an impurity element which imparts n-type conductivity or an impurity element which imparts p-type conductivity is used. Phosphorus (P), arsenic (As), or the like can be used as an impurity element which imparts n-type conductivity. Boron (B), aluminum (Al), gallium (Ga), or the like can be used as an impurity element which imparts p-type conductivity. In this embodiment, phosphorus (P) is used as an impurity element.

Next, contact holes are formed in the insulating film 803 and part of the impurity regions 808 and 809 is exposed. Next, conductive films 810 to 813, which are connected to the impurity regions 808 and 809 via the contact holes, are formed. The conductive films 810 to 813 can be formed by a CVD method, a sputtering method, or the like.

The insulating film 803 can be formed using an inorganic insulating film, an organic resin film, or a siloxane-based insulating film. In the case of using an inorganic insulating film, a film which contains silicon oxide, silicon oxynitride, silicon nitride oxide, carbon, typified by diamond-like carbon (DLC), or the like can be used. In the case of using an organic resin film, an acrylic, an epoxy, a polyimide, a polyamide, polyvinyl phenol, benzocyclobutene, or the like can be used, for example. The insulating film 803 can be formed by a CVD method, a sputtering method, a droplet discharging method, a printing method, or the like, depending on a material of the insulating film 803.

Note that a transistor used for a memory carrier of the invention is not limited to having the structure shown in the drawings of this embodiment. For example, the transistor may have a reverse-staggered structure.

Next, an insulating film 815 is formed, as shown in FIG. 17B. Then, the insulating film 815 is etched to form contact holes which expose parts of the conductive films 810 and 813. From the point of view of planarity, it is desirable that the insulating film 815 be formed of resin, although the insulating film is not limited to being formed of resin, and a film such as a CVD oxide film may be used for the insulating film 815. Alternatively, the contact holes may be formed using a photosensitive resin, without using etching. Next, a conductive film 816 and a conductive film 817 which are in contact with the conductive film 810 and the conductive film 813, respectively, via the contact holes, are formed over the insulating film 815.

Next, an electrode 818 is formed over the insulating film 815 such that it is in contact with the conductive film 816. FIG. 17B shows an example in which the electrode 818 is formed using a conductive film which reflects light well and a reflective liquid crystal element is fabricated; however, the invention is not limited to that structure. A transmissive liquid crystal element can be formed by forming a pixel electrode using a transparent conductive film. Note that in the case of forming a reflective liquid crystal element, it is also possible to use part of the conductive film 816 as an electrode and not provide the electrode 818. Further, the embodiment is not limited to using a liquid crystal element; a display element which uses a display material having a memory property, a light-emitting element typified by an organic light-emitting element (an OLED), or the like can also be used.

Then, an orientation film 819 is formed such that it covers the conductive film 816 and the electrode 818, and rubbing treatment is performed. The orientation film 819 is formed using patterning or the like in a selected region which is to serve as a display device.

Next, a sealant 820 for sealing liquid crystals is formed. Meanwhile, a substrate 823 provided with an electrode 821, which uses a transparent conductive film, and an orientation film 822, which has been subjected to rubbing treatment, is prepared. Then, liquid crystals 824 are delivered by drops into a region surrounded by the sealant 820, and the separately prepared substrate 823 is attached using the sealant 820 such that the electrode 821 and the electrode 818 face each other. Note that a filler may be mixed in with the sealant 820.

Note that a color filter, a shielding film for preventing disinclination (a black matrix), or the like may also be formed. Further, a polarizing plate 825 is attached to a surface of the substrate 823 which is opposite to the surface provided with the electrode 821.

As a transparent conductive film used for the electrode 818 or the electrode 821, a film including indium tin oxide which includes silicon oxide (ITSO), indium tin oxide (ITO), zinc oxide (ZnO), indium zinc oxide (IZO), zinc oxide to which gallium has been added (GZO), or the like can be used, for example. A liquid crystal element 826 corresponds to a portion where the electrode 818, the liquid crystals 824, and the electrode 821 overlap.

A dispenser method (a dripping method) is used for injecting the liquid crystals; however, the invention is not limited thereto. A dipping method (pumping method) in which the liquid crystals are injected after attaching the substrate 823 may be used.

Next, an antenna 831, with which a support 830 is provided, is electrically connected to the conductive film 817. Electrical connection between the antenna 831 and the conductive film 817 can be performed by pressure bonding the antenna 831 and the conductive film 817 using an anisotropic conductive film (ACF) 832. Pressure bonding may also be performed using an anisotropic conductive paste (ACP) or the like as an alternative to the anisotropic conductive film. Alternatively, the connection can be performed using a conductive adhesive, such as a silver paste, a copper paste, a carbon paste, or the like; soldering; or the like.

Further, in this embodiment, an example in which the separately prepared antenna 831 is electrically connected to the semiconductor element after the semiconductor element has been formed is described; however, the invention is not limited to this structure. The antenna may be formed over the same substrate as the semiconductor element. In that case, a conductive film which serves as the antenna is formed such that a part of the conductive film which serves as the antenna is in contact with the conductive film 817. The conductive film which serves as the antenna can be formed using a metal such as silver (Ag), gold (Au), copper (Cu), palladium (Pd), chromium (Cr), platinum (Pt), molybdenum (Mo), titanium (Ti), tantalum (Ta), tungsten (W), aluminum (Al), iron (Fe), cobalt (Co), zinc (Zn), tin (Sn), nickel (Ni), or the like. Alternatively, a film formed of an alloy containing any of the above metals as its main component or a film formed using a compound containing any of the above metals may be used as the conductive film which serves as the antenna, rather than a film formed of any of the above metals. For the conductive film which serves as the antenna, a single layer of any of the above-mentioned films or a stacked layer which includes a plurality of any of the above-mentioned films may be used.

The conductive film which serves as the antenna can be formed by a CVD method; a sputtering method; a printing method, such as screen printing, gravure printing, or the like; a droplet discharging method; a dispenser method; a plating method; a photolithography method; an evaporation method; or the like.

For example, in the case of using a screen printing method, the conductive film which serves as the antenna can be formed by selectively printing a conductive paste, in which conductive particles having a grain size of from several nanometers to several tens of micrometers are dispersed in an organic resin, over the insulating film 733. The conductive particles can be formed using silver (Ag), gold (Au), copper (Cu), nickel (Ni), platinum (Pt), palladium (Pd), tantalum (Ta), molybdenum (Mo), tin (Sn), lead (Pb), zinc (Zn), chromium (Cr), titanium (Ti), or the like. Alternatively, an alloy containing any of the above-mentioned metals as its main component or a compound containing any of the above-mentioned metals may be used to form the conductive particles, instead of a film formed of any of the above-mentioned metals. Alternatively, fine particles or dispersive nanoparticles of silver halide can be used. As an organic resin contained in the conductive paste, a polyimide, a siloxane-based resin, an epoxy resin, a silicon resin, or the like can be used.

Examples of alloys of the above-mentioned metals are combinations of silver (Ag) and palladium (Pd), silver (Ag) and platinum (Pt), gold (Au) and platinum (Pt), gold (Au) and palladium (Pd), and silver (Ag) and copper (Cu). Alternatively, conductive particles in which copper (Cu) is coated with silver (Ag), or the like can be used, for example.

Note that when forming the conductive film which serves as the antenna, preferably baking is performed after the conductive paste is applied by a printing method or a droplet discharging method. For example, in the case where conductive particles (with a grain size of greater than or equal to one nm and less than or equal to 100 nm, for example) containing silver as their main component are used for the conductive paste, the conductive film which serves as the antenna can be formed by baking the conductive paste at a temperature in the range of 150 to 300° C. Baking may be performed by lamp annealing which uses an infrared lamp, a xenon lamp, a halogen lamp, or the like; furnace annealing which uses an electric furnace; or a laser annealing method which uses an excimer laser or an Nd:YAG laser. Alternatively, fine particles containing solder or lead-free solder as their main component may be used. In that case, it is preferable to use fine particles having a grain size of 20 μm or less. Solder and lead-free solder have advantages such as low cost.

When a printing method or a droplet discharging method is used, the conductive film which serves as the antenna can be formed without using an exposure mask. Further, when a printing method or a droplet discharging method is used, waste of material which would be removed by etching can be avoided, as opposed to the case of using a photolithography method. Further, since it is not necessary to use an expensive exposure mask, the cost of manufacturing a memory carrier can be reduced.

Note that this embodiment can be combined as appropriate with any of the above-described embodiment modes or embodiments.

This application is based on Japanese Patent Application Serial No. 2007-043066 filed on Feb. 23, 2007 with the Japanese Patent Office, the entire contents of which are hereby incorporated by reference.

What is claimed is:

1. A memory carrier comprising:
a memory storing data;
a control circuit configured to read the data from the memory in accordance with a signal transmitted wirelessly from an interrogator;
a converter configured to convert the data in accordance with an algorithm;
an image signal generating circuit configured to generate an image signal using converted data; and
a display device which displays an image using the image signal.

2. The memory carrier according to claim 1, wherein the display device comprises a display element comprising a display material having a memory property.

3. The memory carrier according to claim 1, wherein the memory is a rewritable nonvolatile memory.

4. The memory carrier according to claim 1, further comprising an antenna circuit configured to receive a radio wave from the interrogator and to generate the signal.

5. The memory carrier according to claim 1, wherein the display device comprises a display element comprising a display material comprising a charged fine particle.

6. The memory carrier according to claim 1, wherein the display device displays a one-dimensional code.

7. The memory carrier according to claim 1, wherein the display device displays a two-dimensional code.

8. The memory carrier according to claim 1, wherein the memory carrier is a card.

9. A memory carrier comprising:
a memory storing data;
a control circuit configured to read the data from the memory in accordance with a signal transmitted wirelessly from an interrogator;
an image signal generating circuit configured to generate an image signal using the data; and
a display device which displays a code using the image signal.

10. The memory carrier according to claim 9, wherein the display device comprises a display element comprising a display material having a memory property.

11. The memory carrier according to claim 9, wherein the memory is a rewritable nonvolatile memory.

12. The memory carrier according to claim 9, further comprising an antenna circuit configured to receive a radio wave from the interrogator and to generate the signal.

13. The memory carrier according to claim 9, wherein the display device comprises a display element comprising a display material comprising a charged fine particle.

14. The memory carrier according to claim 9, wherein the display device displays a one-dimensional code.

15. The memory carrier according to claim 9, wherein the display device displays a two-dimensional code.

16. The memory carrier according to claim 9, wherein the memory carrier is a card.

17. A memory carrier comprising:
a first memory storing first data;
a second memory storing second data obtained by converting the first data in accordance with an algorithm;
a control circuit configured to read the second data from the second memory in accordance with a first signal transmitted wirelessly from an interrogator;
an image signal generating circuit configured to generate an image signal using the second data; and
a display device which displays an image using the image signal.

18. The memory carrier according to claim 17, wherein the display device comprises a display element comprising a display material having a memory property.

19. The memory carrier according to claim 17, wherein the first memory is a rewritable nonvolatile memory.

20. The memory carrier according to claim 17, further comprising an antenna circuit configured to receive a radio wave from the interrogator and to generate the signal.

21. The memory carrier according to claim 17, wherein the display device comprises a display element comprising a display material comprising a charged fine particle.

22. The memory carrier according to claim 17, wherein the display device displays a one-dimensional code.

23. The memory carrier according to claim 17, wherein the display device displays a two-dimensional code.

24. The memory carrier according to claim 17, wherein the memory carrier is a card.

25. A method for driving a memory carrier which comprises a memory and a display device comprising:
reading data from the memory in accordance with a first signal transmitted wirelessly from an interrogator;
generating a second signal by using the data:
transmitting the second signal wirelessly to the interrogator;
converting the data in accordance with an algorithm;
generating an image signal by using the converted data; and
displaying an image on the display device by using the image signal.

26. The method for driving the memory carrier according to claim 25, wherein the display device comprises a display element comprising a display material having a memory property.

27. The method for driving the memory carrier according to claim 25, wherein the memory is a rewritable nonvolatile memory.

28. The method for driving the memory carrier according to claim 25, further comprising an antenna circuit configured to receive a radio wave from the interrogator and to generate the signal.

29. The method for driving the memory carrier according to claim 25, wherein the display device displays a one-dimensional code.

30. The method for driving the memory carrier according to claim 25, wherein the display device displays a two-dimensional code.

31. The method for driving the memory carrier according to claim 25, wherein the step of converting the data in accordance with the algorithm is performed only when the step of transmitting the second signal wirelessly to the interrogator is not achieved.

32. The method for driving the memory carrier according to claim 25, wherein the memory carrier is a card.

33. A method for driving a memory carrier which comprises a first memory, a second memory, and a display device comprising:
reading first data from the first memory in accordance with a first signal transmitted wirelessly from an interrogator;
generating a second signal by using the first data:
transmitting the second signal wirelessly to the interrogator;
reading second data from the second memory wherein the second data is obtained by converting the first data in accordance with an algorithm;
generating an image signal by using the second data; and
displaying an image on the display device by using the image signal.

34. The method for driving the memory carrier according to claim 33, wherein the display device comprises a display element comprising a display material having a memory property.

35. The method for driving the memory carrier according to claim 33, wherein the first memory is a rewritable nonvolatile memory.

36. The method for driving the memory carrier according to claim 33, further comprising an antenna circuit configured to receive a radio wave from the interrogator and to generate the signal.

37. The method for driving the memory carrier according to claim 33, wherein the display device displays a one-dimensional code.

38. The method for driving the memory carrier according to claim 33, wherein the display device displays a two-dimensional code.

39. The method for driving the memory carrier according to claim 33, wherein the step of reading the second data from the second memory is performed only when the step of transmitting the second signal wirelessly to the interrogator is not achieved.

40. The method for driving the memory carrier according to claim 33, wherein the memory carrier is a card.
